(19) United States
(12) Patent Application Publication
(10) Pub. No.: US 2024/0080867 A1
(43) Pub. Date: Mar. 7, 2024

(54) METHOD AND APPARATUS FOR SIDELINK COMMUNICATIONS OF POWER SAVING UES IN SHARED RESOURCE POOL

(71) Applicant: Huawei Technologies Co., Ltd., Shenzhen (CN)

(72) Inventors: Guosen Yue, Edison, NJ (US); Brian Classon, St. Pete Beach, FL (US); Vipul Desai, Palatine, IL (US)

(21) Appl. No.: 18/388,516

(22) Filed: Nov. 9, 2023

Related U.S. Application Data
(63) Continuation of application No. PCT/US2022/023531, filed on Apr. 5, 2022.
(60) Provisional application No. 63/186,610, filed on May 10, 2021.

(51) Int. Cl. H04W 72/40; H04W 72/566

(52) U.S. Cl. CPC H04W 72/40; H04W 72/566

(57) ABSTRACT

A first user equipment (UE) reserves a resource from a resource pool for transmission of sidelink data associated with a packet priority, and transmits a location of the reserved resource, an indicator indicating whether a reservation priority is assigned to the sidelink data, and a priority value that is associated with the packet priority or the reservation priority. A second UE receives the location of the reserved resource, the indicator and the priority value, and based thereon performs sidelink communication. A UE may also select, from a resource pool based on a packet priority of sidelink data to be transmitted, a subset of resources usable by the UE, and transmit the sidelink data using a resource selected from the subset of resources. The resource pool includes one or more subsets of resources each of which is associated with a set of priority values.

### CROSS-REFERENCE TO RELATED APPLICATIONS

This application is a continuation of International Application No. PCT/US2022/023531, filed on Apr. 5, 2022, and entitled “Method and Apparatus for Sidelink Communications of Power Saving UEs In Shared Resource Pool,” which claims priority to U.S. Provisional Application No. 63/186,610, filed on May 10, 2021 and entitled “Method and Apparatus of Power Saving UE in a Shared Resource Pool in Sidelink Communications,” which applications are incorporated by reference herein in its entirety.

### TECHNICAL FIELD

The present disclosure relates generally to wireless communications, and in particular embodiments, to techniques and mechanisms for sidelink communications of power saving UEs in a shared resource pool.

### BACKGROUND

The third generation partnership project (3GPP) has been developing and standardizing several important features with fifth generation (5G) new radio (NR) access technology. In Release-16 (Rel-16), a work item (WI) for NR vehicle-to-everything (V2X) wireless communication with the goal of providing 5G-compatible high-speed reliable connectivity for vehicular communications was completed. This work item provided the basics of NR sidelink communication for applications, such as safety systems and autonomous driving applications. High data rates, low latencies, and high reliabilities were some of the areas investigated and standardized in this work item.

In Release-17 (Rel-17), a work item for sidelink enhancement was approved to further enhance the capabilities and performance of sidelink communications. One objective of the work item is to introduce a user equipment (UE) coordination mechanism to facilitate sidelink communications between UEs. For example, a UE (e.g., UE A) may provide, to another UE (e.g., UE B), information about resources to use in its resource selection. It is desirable to develop further mechanisms for facilitating and enhancing sidelink communications.

### SUMMARY

Technical advantages are generally achieved, by embodiments of this disclosure which describe a method and apparatus for sidelink communications of power saving UEs in a shared resource pool.

According to one aspect of the present disclosure, a method is provided that includes: reserving, by a user equipment (UE), a resource for transmitting data on a sidelink, the data associated with a packet priority; and transmitting, by the UE on the sidelink, a resource location of the reserved resource, an indicator indicating whether a reservation priority different than the packet priority is assigned to the data, and a priority value that is associated with the packet priority or the reservation priority.

Optionally, in any of the preceding aspects, the priority value represents the reservation priority.

Optionally, in any of the preceding aspects, the method further includes: determining, by the UE, the priority value based on a mapping between the packet priority of the data, the reservation priority, and the indicator.

Optionally, in any of the preceding aspects, the priority value represents the packet priority of the data.

Optionally, in any of the preceding aspects, the method further includes: determining, by the UE, the value of the indicator based on a mapping between the packet priority of the data, the reservation priority and the indicator.

Optionally, in any of the preceding aspects, the method further includes: obtaining, by the UE, the mapping from a mapping table or based on a mapping function.

Optionally, in any of the preceding aspects, the indicator and the priority value are transmitted within a sidelink control information (SCI) message.

Optionally, in any of the preceding aspects, the indicator is a one-bit or two-bit indicator.

Optionally, in any of the preceding aspects, the method further includes: selecting, by the UE, the reserved resource from a resource pool configured for sidelink communication using random selection.

According to another aspect of the present disclosure, a method is provided that includes: receiving, by a first user equipment (UE) from a second UE, a signaling indicating that a first resource has been reserved by the second UE for transmission of first data on a sidelink, the first resource belonging to a resource pool configured for sidelink communication, the first data associated with a packet priority; receiving, by the first UE from the second UE, an indicator indicating whether a reservation priority different than the packet priority is configured for the first data, and a priority value that is associated with the packet priority or the reservation priority; and performing, by the first UE, sidelink communication based on the received signaling, the indicator and the priority value.

Optionally, in any of the preceding aspects, the method further includes determining, by the first UE based on the indicator and the priority value, whether to exclude the first resource from the resource pool when selecting resources for sidelink transmission by the first UE.

Optionally, in any of the preceding aspects, the priority value represents the reservation priority.

Optionally, in any of the preceding aspects, the method further includes: determining, by the first UE, the packet priority of the first data, based on a mapping between the packet priority of the first data, the reservation priority, and the indicator.

Optionally, in any of the preceding aspects, the priority value represents the packet priority of the first data.

Optionally, in any of the preceding aspects, the method further includes: determining, by the first UE, the reservation priority of the first data, based on a mapping between the reservation priority of the first data, the packet priority, and the indicator.

Optionally, in any of the preceding aspects, the method further includes: obtaining, by the first UE, the mapping from a mapping table or based on a mapping function.

Optionally, in any of the preceding aspects, the method further includes: reserving, by the first UE before receiving the signaling, the first resource from the resource pool for transmission of second data on the sidelink.

Optionally, in any of the preceding aspects, the method further includes: re-selecting, by the first UE, a second resource from the resource pool for the transmission of the second data, when the reservation priority of the first data is higher than a packet priority of the second data.

Optionally, in any of the preceding aspects, the method further includes: continuing, by the first UE, to reserve the first resource for the transmission of the second data, when the reservation priority of the first data is lower than a packet priority of the second data.

Optionally, in any of the preceding aspects, the indicator and the priority value are received in a sidelink control information (SCI) message.

Optionally, in any of the preceding aspects, the indicator is a one-bit or two-bit indicator.

According to another aspect of the present disclosure, a method is provided that includes: selecting, by a user equipment (UE) from a resource pool based on a packet priority of data to be transmitted by the UE on a sidelink, a first subset of resources usable by the UE for transmitting the data, the resource pool comprising one or more subsets of resources according to a resource pool configuration, and each subset of the one or more subsets being associated with a set of priority values; and transmitting, by the UE on the sidelink, the data using a resource selected from the first subset of resources.

Optionally, in any of the preceding aspects, the first subset of resources is selected when the packet priority of the data satisfies a condition associated with the set of priority values of the first subset of resources.

Optionally, in any of the preceding aspects, selecting the first subset of resources comprise: comparing, by the UE, a priority value of the packet priority of the data with the set of priority values.

Optionally, in any of the preceding aspects, the set of priority values comprises a priority threshold or a range of priorities.

Optionally, in any of the preceding aspects, selecting the first subset of resources comprise: determining, by the UE, whether a priority value of the packet priority falls within the range of priorities of the first subset of resources.

Optionally, in any of the preceding aspects, the resource pool configuration is preconfigured.

Optionally, in any of the preceding aspects, the resource pool configuration is preconfigured by the network.

Optionally, in any of the preceding aspects, the resource pool configuration is received by the UE through radio resource control (RRC) signaling.

Optionally, in any of the preceding aspects, the resource pool configuration is received by the UE from another UE.

According to another aspect of the present disclosure, an apparatus is provided that includes a non-transitory memory storage comprising instructions; and one or more processors in communication with the memory storage, wherein the instructions, when executed by the one or more processors, cause the apparatus to perform a method of any of the preceding aspects.

According to another aspect of the present disclosure, a non-transitory computer-readable media is provided. The non-transitory computer-readable media stores computer instructions, that when executed by one or more processors, cause the one or more processors to perform a method of any of the preceding aspects.

According to another aspect of the present disclosure, a system is provided that includes: a first user equipment (UE); and a second UE in communication with the first UE. The first UE is configured to: reserve a resource for transmitting data on a sidelink, the data associated with a packet priority; and transmit, on the sidelink, a resource location of the reserved resource, an indicator indicating whether a reservation priority different than the packet priority is assigned to the data, and a priority value that is associated with the packet priority or the reservation priority. The second UE is configured to: receive the resource location of the reserved resource, the indicator and the priority value; and perform sidelink communication based on the resource location of the reserved resource, the indicator and the priority value.

The above aspects have advantages of reducing sidelink power consumption, reducing resource collisions and improving sidelink communication performance.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of an embodiment communications system;

FIG. 2 is a diagram of example in-coverage (IC) and out-of-coverage (OOC) scenarios in sidelink communication;

FIG. 3 is a diagram of an example resource pool;

FIG. 4 is a diagram of embodiment resources for PSCCH, PSSCH and PSFCH;

FIG. 5 is a diagram showing example timing of sensing and resource selection for Rel-16 NR sidelink transmission;

FIG. 6 is a flow diagram of an embodiment sidelink communication method, highlighting operations of a power saving transmitting UE;

FIG. 7 is a flow diagram of an embodiment sidelink communication method, highlighting operations of a sensing UE;

FIG. 8 is a flow diagram of an embodiment sidelink communication method, highlighting operations of a Rel-17 sensing UE;

FIG. 9 is a flow diagram of an embodiment sidelink communication method, highlighting operations of a Rel-16 sensing UE;

FIG. 10 is a flow diagram of another embodiment sidelink communication method, highlighting operations of a power saving UE;

FIG. 11 is a flow diagram of another embodiment sidelink communication method, highlighting operations of a Rel-17 sensing UE;

FIG. 12 is a diagram of an embodiment shared resource pool partitioned into sub-pools;

FIG. 13 is a diagram of another embodiment shared resource pool partitioned into sub-pools;

FIG. 14 is a flow diagram of an embodiment method for sidelink communication;

FIG. 15 is a flow diagram of another embodiment method for sidelink communication;

FIG. 16 is a flow diagram of another embodiment method for sidelink communication;

FIG. 17 is a diagram of another embodiment communication system;

FIG. 18A is a diagram of an embodiment end device (ED);

FIG. 18B is a diagram of an embodiment base station; and

FIG. 19 is a block diagram of an embodiment computing system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

In sidelink communications, a user equipment (UE, e.g., UE1) that is to send data on a sidelink may reserve a resource from a resource pool for transmission of the data, and send a signaling indicating reservation of the resource to other UEs. A UE (e.g., UE2) capable of performing resource re-evaluation and pre-emption may receive the signaling, and determine, based thereon, whether there is resource collision and whether it needs to re-select a resource from the resource pool for its own sidelink transmission, so as to avoid collision. However, a UE3 performing random resource selection, e.g., a power saving UE, if it selects the same resource for sidelink transmission, cannot avoid the resource collision. The power saving UE does not monitor sidelink resources reserved by other UEs and does not perform resource re-evaluation and pre-emption.

Embodiments of the present disclosure provide sidelink communication methods, which may be used to reduce or avoid resource collision between a UE performing resource re-evaluation and pre-emption and a UE performing random resource selection without performing resource re-evaluation and pre-emption. The embodiments have advantages of reducing sidelink power consumption, reducing resource collisions and improving sidelink communication performance.

In some embodiments, a first UE may reserve a resource from a resource pool for transmitting data on a sidelink, and the data is associated with a packet priority. The first UE may transmit a resource location of the reserved resource, an indicator indicating whether a reservation priority different than the packet priority is assigned to the data, and a priority value that is associated with the packet priority or the reservation priority. A second UE may receive the resource location of the reserved resource, the indicator and the priority value, and perform sidelink communication based thereon. The second UE may determine, based on the indicator and the priority value, whether to exclude the resource, which is reserved by the first UE, from the resource pool when selecting resources for sidelink transmission by the second UE.

In some embodiments, a UE may select, from a resource pool based on a packet priority of data to be transmitted by the UE on a sidelink, a subset of resources that is usable by the UE for transmitting the data. The resource pool may include one or more subsets of resources according to a resource pool configuration, and each subset of the one or more subsets is associated with a set of priority values. The UE may transmit, on the sidelink, the data using a resource selected from the subset of resources. More details are provided in the following.

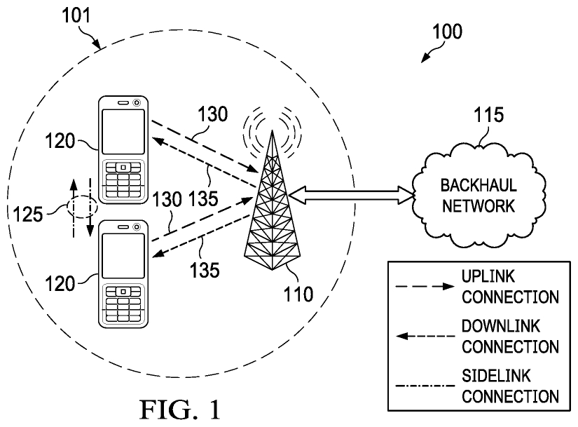

FIG. 1 is a diagram of an embodiment communications system 100. Communications system 100 includes an access node 110, with coverage area 101, serving user equipments (UEs), such as UEs 120. Access node 110 is connected to a backhaul network 115 that provides connectivity to services and the Internet. In a first operating mode, communications to and from a UE passes through access node 110. In a second operating mode, communications to and from a UE do not pass through access node 110, however, access node 110 typically allocates resources used by the UE to communicate when specific conditions are met. Communication between a UE pair in the second operating mode occurs over sidelinks 125, comprising uni-directional communication links. Communication in the second operating mode may be referred to as sidelink communication. Communication between a UE and access node pair also occur over uni-directional communication links, where the communication links from UEs 120 to the access node 110 are referred to as uplinks 130, and the communication links from the access node 110 to the UEs 120 are referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on. UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

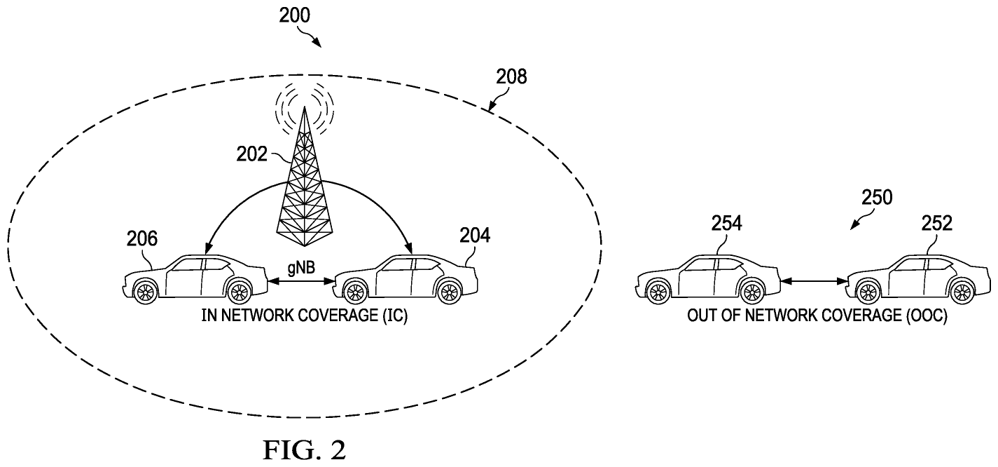

The sidelink communication can either be in-coverage, or out-of-coverage. For an in-coverage (IC) operation, a central node (e.g., access node, eNB, gNB, etc.) may be present and used to manage sidelinks. For an out-of-coverage (OOC) operation, the system operation is fully distributed, and UEs select resources on their own. FIG. 2 is a diagram showing an example IC scenario 200 and an example OOC scenario 250. In the IC scenario 200, a gNB 202 is configured to manage sidelink communications between UEs 204 and 206 that are in the coverage of the gNB 202. UEs 204 and 206 can be considered as mode 1 UEs. In the GOC scenario 250, UEs 252 and 254 perform sidelink communication with each other without management of a central node, and select resources on their own for the sidelink communication. UEs 252 and 254 can be considered as mode 2 UEs. In an embodiment of the present disclosure, some UEs may be facilitated or assisted to select their resources for sidelink communication.

For the purpose of sidelink communications, the notion of resource pools was introduced for LTE sidelink and is being reused for NR sidelink. A resource pool is a set of resources that may be used for sidelink communication. Resources in a resource pool may be configured for different channels and signals, such as control channels, shared channels, feedback channels, broadcast channels (e.g., a master information block), synchronization signals, reference signals, and so on. 3GPP TS 38.331, “NR; Radio Resource Control (RRC); Protocol specification,” V16.4.1, March 30, 3021, which is herein incorporated by reference, defines rules on how the resources in the resource pool are shared and used for a particular configuration of the resource pool. A UE performing sidelink transmission may select a resource from a resource pool configured for sidelink communication, and transmit signals in the resource on a sidelink.

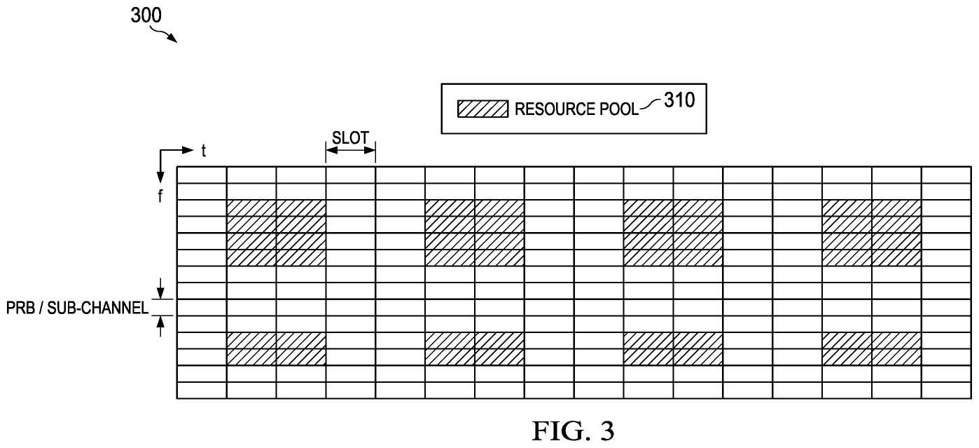

A resource pool for sidelink communication may be configured in units of slots in the time domain and physical resource blocks (PRBs) or sub-channels in the frequency domain. A sub-channel may include one or more PRBs. FIG. 3 is a diagram 300 of an example resource pool in the time-frequency resource grid. FIG. 3 shows a resource pool 310 including a plurality of resources (shaded rectangles) in different slots and PRBs/sub-channels.

According to 3GPP TS 38.211, “NR; Physical channels and modulation,” V16.5.0, March 30, 3021, which is herein incorporated by reference in its entirety, for NR mobile broadband (MBB), each physical resource block (PRB) in the grid is defined as including a slot of 14 consecutive orthogonal frequency division multiplexing (OFDM) symbols in the time domain and 12 consecutive subcarriers in the frequency domain, i.e., each resource block includes 12×14 resource elements (REs). Each RE includes one OFDM symbol and one subcarrier. (When used as a frequency-domain unit, a PRB is 12 consecutive subcarriers.) There are 14 symbols in a slot when a normal cyclic prefix is used, and 12 symbols in a slot when an extended cyclic prefix is used. The duration of a symbol is inversely proportional to the subcarrier spacing (SCS). For a {15, 30, 60, 120} kHz SCS, the duration of a slot is {1, 0.5, 0.25, 0.125} ms, respectively. A PRB may be allocated for communicating a channel and/or a signal, e.g., a control channel, a shared channel, a feedback channel, a reference signal, or a combination thereof. In addition, some REs of a PRB may be reserved. A similar time-frequency resource structure may be used on the sidelink as well. A communication resource, e.g., for sidelink communication, may be a PRB, a set of PRBs, a code (if code division multiple access (CDMA) is used, similarly to that used for a physical uplink control channel (PUCCH)), a physical sequence, a set of REs, or a combination thereof.

As used herein, a UE participating in sidelink communication is referred to as a source UE or a transmit UE when the UE is to transmit signals on a sidelink to another UE. A UE participating in sidelink communication is referred to as a destination UE, a receive (or receiving) UE or a recipient, when the UE is to receive signals on a sidelink from another UE. Two UEs communicate with each other on a sidelink are also referred to as a UE pair in sidelink communication.

A physical sidelink control channel (PSCCH) may carry sidelink control information (SCI). A source UE uses the SCI to schedule transmission of data on a physical sidelink shared channel (PSSCH) or reserve a resource for the transmission of the data on the PSSCH. The SCI may convey the time and frequency resources of the PSSCH, and/or parameters for hybrid automatic repeat request (HARQ) process, such as a redundancy version, a process id (or ID), a new data indicator, and resources for the physical sidelink feedback channel (PFSCH). The time and frequency resources of the PSSCH may be referred to as resource assignment or allocation, and may be indicated in the time resource assignment field and/or a frequency resource assignment field, i.e., resource locations. The PFSCH may carry an indication (e.g., a HARQ acknowledgement (HARQ-ACK) or negative acknowledgement (HARQ-NACK)) indicating whether a destination UE decoded the payload carried on the PSSCH correctly. The SCI may also carry a bit field indicating or identifying the source UE. In addition, the SCI may carry a bit field indicating or identifying the destination UE. The SCI may further include other fields to carry information such as a modulation coding scheme used to encode the payload and modulate the coded payload bits, a demodulation reference signal (DMRS) pattern, antenna ports, a priority of the payload (transmission), and so on. A sensing UE performs sensing on a sidelink, i.e., receiving a PSCCH sent by another UE, and decoding SCI carried in the PSCCH to obtain information of resources reserved by the another UE, and determining resources for sidelink transmissions of the sensing UE.

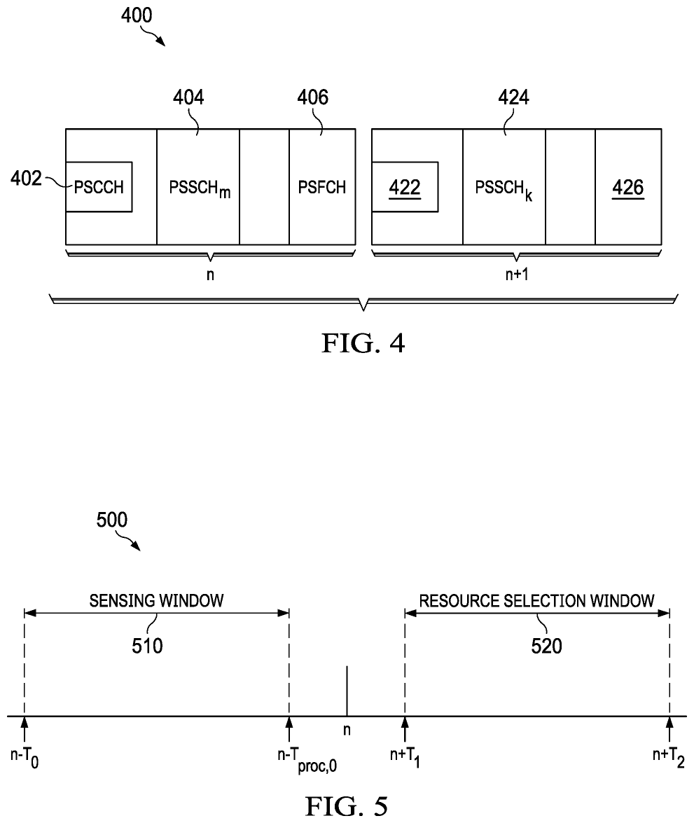

FIG. 4 is a diagram 400 of embodiment resources for PSCCH, PSSCH and PSFCH. FIG. 4 shows the resources in slot n and slot n+1. Within slot n, there are a resource region 402 for PSCCH, a resource region 404 for PSSCH (PSSCHₘ as shown), a resource region 406 for PSFCH. Within slot n+1, there are a resource region 422 for PSCCH, a resource region 424 for PSSCH (PSSCHₖ as shown), a resource region 426 for PSFCH.

In NR, there are two stages for the SCI: a first stage (shown below) and a second stage. The first stage SCI may indicate the resources for the second stage SCI. A first stage SCI can be transmitted in the PSCCH. A second stage SCI can be transmitted in the PSSCH. The SCI may have the following formats: SCI format 1-A, SCI format 2-A and SCI format 2-B.

SCI Format 1-A

SCI format 1-A is used for scheduling of PSSCH and 2nd-stage-SCI on PSSCH.

The following information is transmitted by means of the SCI format 1-A:
Priority—3 bits as specified in clause 5.4.3.3 of TS 23.287 and clause 5.22.1.3.1 of TS 38.321.
Frequency resource assignment

$$- ⌈ {log}_{2} ( \frac{{N}_{subChannel}^{SL} ( {N}_{subChannel}^{SL} + 1 )}{2} ) ⌉ bits$$

when the
value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits$$

when the value of the higher layer parameter sl-MaxNumPerReserve is configured to 3, as defined in clause 8.1.5 of TS 38.214.
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.5 of TS 38.214.
Resource reservation period—┌log₂ N_{rsv_period}┘ bits as defined in clause 16.4 of TS 38.213, where N_{rsv_period} is the number of entries in the higher layer parameter sl-ResourceReservePeriodList, if higher layer parameter sl-MultiReserveResource is configured; 0 bit otherwise.
DMRS pattern—┌log₂ Nₚₐₜₜₑᵣₙ┘ bits as defined in clause 8.4.1.1.2 of TS 38.211, where Nₚₐₜₜₑᵣₙ is the number of DMRS patterns configured by higher layer parameter sl-PSSCH-DMRS-TimePatternList.
2^{nd}-stage SCI format—2 bits as defined in Table 8.3.1.1-1 of TS 38.212.
Beta_offset indicator—2 bits as provided by higher layer parameter sl-BetaOffsets2ndSCl and Table 8.3.1.1-2 of TS 38.212.
Number of DMRS port—1 bit as defined in Table 8.3.1.1-3 of TS 38.212.
Modulation and coding scheme—5 bits as defined in clause 8.1.3 of TS 38.214.
Additional MCS table indicator—as defined in clause 8.1.3.1 of TS 38.214: 1 bit if one MCS table is configured by higher layer parameter sl-Additional-MCS-Table; 2 bits if two MCS tables are configured by higher layer parameter sl-Additional-MCS-Table; 0 bit otherwise.
PSFCH overhead indication—1 bit as defined clause 8.1.3.2 of TS 38.214 if higher layer parameter sl-PSFCH-Period=2 or 4; 0 bit otherwise.
Reserved—a number of bits as determined by higher layer parameter sl-NumReservedBits, with value set to zero.

TS 38.321, “3rd Generation Partnership Project; Technical Specification Group Radio Access Network; NR; Medium Access Control (MAC) protocol specification (Release 16),” v 16.4.0, Mar. 29, 2021, and TS 23.287, “3rd Generation Partnership Project; Technical Specification Group Services and System Aspects; Architecture enhancements for 5G System (5GS) to support Vehicle-to-Everything (V2X) services (Release 16),” v 16.5.0, December 2020, are herein incorporated by reference in their entireties.

SCI Format 2-A

SCI format 2-A is used for the decoding of PSSCH, with HARQ operation when HARQ-ACK information includes ACK or NACK, or when there is no feedback of HARQ-ACK information.

The following information may be transmitted by means of the SCI format 2-A (according to 3GPP TS 38.212, “NR; Multiplexing and channel coding,” v16.5.0, Mar. 30, 2021, which is hereby incorporated herein by reference in its entirety):
HARQ process number—┌log₂ N_{process}┘ bits as defined in clause 16.4 of TS 38.213, “NR; Physical layer procedures for control,” v16.5.0, Mar. 30, 2021, which is hereby incorporated herein by reference in its entirety.
New data indicator—1 bit as defined in clause 16.4 of TS 38.213.
Redundancy version—2 bits as defined in clause 16.4 of TS 38.214, “NR; Physical layer procedures for data,” v16.5.0, Mar. 30, 2021, which is hereby incorporated herein by reference in its entirety.
Source ID—8 bits as defined in clause 8.1 of TS 38.214.
Destination ID—16 bits as defined in clause 8.1 of TS 38.214.
HARQ feedback enabled/disabled indicator—1 bit as defined in clause 16.3 of TS 38.213.
Cast type indicator—2 bits as defined in Table 8.4.1.1-1 of TS 38.212.
CSI request—1 bit as defined in clause 8.2.1 of TS 38.214. Table 8.4.1.1-1 of TS 38.212 is provided below.

TABLE 8.4.1.1-1
Cast type indicator

| Value of Cast type indicator | Cast type |
|---|---|
| 00 | Broadcast |
| 01 | Groupcast |
| 10 | Unicast |
| 11 | Reserved |

SCI Format 2-B

SCI format 2-B is used for the decoding of PSSCH, with HARQ operation when HARQ-ACK information includes only NACK, or when there is no feedback of HARQ-ACK information.

The following information may be transmitted by means of the SCI format 2-B (according to TS 38.212):
HARQ process number—┌log₂ N_{process}┘ bits as defined in clause 16.4 of TS 38.213.
New data indicator—1 bit as defined in clause 16.4 of TS 38.213.
Redundancy version—2 bits as defined in clause 16.4 of TS 38.214.
Source ID—8 bits as defined in clause 8.1 of TS 38.214.
Destination ID—16 bits as defined in clause 8.1 of TS 38.214.
HARQ feedback enabled/disabled indicator—1 bit as defined in clause 16.3 of TS 38.213.
Zone ID—12 bits as defined in clause 5.8.1.1 of TS 38.331 which is hereby incorporated herein by reference in its entirety.
Communication range requirement—4 bits as defined in TS 38.331.

TS 38.331 specifies higher layer messages for configuring PSCCH, and specifies an information element (IE) SL-PSCCH-Config-r16 as shown below:

```
SL-PSCCH-Config-r16 ::= SEQUENCE {
  sl-TimeResourcePSCCH-r16 ENUMERATED {n2, n3} OPTIONAL,
  -- Need M
  sl-FreqResourcePSCCH-r16 ENUMERATED {n10,n12, n15, n20,
n25} OPTIONAL, -- Need M
  sl-DMRS-ScrambleID-r16 INTEGER (0..65535) OPTIONAL, --
  Need M
  sl-NumReservedBits-r16 INTEGER (2..4) OPTIONAL, -- Need M
  ...
}
```

SL-PSCCH field descriptions

sl-FreqResourcePSCCH
Indicates the number of PRBs for PSCCH in a resource pool where
it is not greater than the number PRBs of the subchannel.
sl-DMRS-ScrambleID
Indicates the initialization value for PSCCH DMRS scrambling.
sl-NumReservedBits
Indicates the number of reserved bits in first stage SCI.
sl-TimeResourcePSCCH
Indicates the number of symbols of PSCCH in a resource pool.

In Release-16, 3GPP introduced NR sidelink communication between devices such as UEs, in addition to the typical Downlink and Uplink transmission. Sidelink-communication capable devices may regularly exchange control/data information with each other.

In Release-16, two mechanisms, namely, re-evaluation and pre-emption, were introduced in sidelink communications to reduce the collision probability and improve the packet reception ratio performance.

Re-evaluation mechanism: After a transmit UE selects a sidelink resource and reserves the selected sidelink resource, it can continue a sensing process to check whether the reserved resource is still available. To achieve this, the UE may keep monitoring SCI on sidelink resources and perform a resource selection procedure, e.g., the procedure as defined in TS38.214, Section 8.14, performing a resource exclusion process in a reduced resource selection window based on sensing outcome to form an available resource set. If the reserved resource is not in the available resource set, the UE performs resource re-selection and selects a new resource to avoid the potential collision. As an example, the UE may determine, from a resource pool, a set of resources that is available for the UE to use for sidelink communication. The UE may select a resource from the available resource set and reserves the selected resource. The UE may then re-determine the resource set, e.g., by excluding one or more resources that are not available (e.g., based on a received SCI indicating a resource reserved by another UE) or adding one or more resources that are available. The UE may check whether the selected resource is included in the re-determined resource set (or referred to as an updated resource set). If the selected resource is not included in the re-determined resource set (which may indicate that this resource is not available for the UE anymore), the UE may re-select a resource from the re-determined resource set for sidelink communication.

Pre-emption mechanism: After a transmit UE (e.g., UE1) selects and reserves a sidelink resource, it can continue a sensing process to check whether the reserved resource is still available, as described above. In an example, UE1 may find out that the reserved resource is not included in the updated available resource set and occupied by another UE (e.g., UE2), e.g., by decoding SCI 1 from UE2. UE2 may be referred to as a collided UE. In this case, UE1 may detect a priority of data to be transmitted by UE2. If a priority of data to be transmitted by UE1 (referred to as a sensing UE, as it performs the sensing process) is lower than that of the UE2's data, the sensing UE (UE1) may release its reserved resource and re-select a resource in the resource selection window, e.g., in the updated available resource set. If UE1's data has a higher priority, UE1 may continue to reserve the resource and transmit its data using the reserved resource on sidelink.

There are 8 packet priority levels for sidelink data traffic, i.e., 1, 2, . . . , 8, indicated by a 3-bit number p in a priority field of SCI in the SCI format 1-A. p is from 0 to 7, and a value of a priority (or priority level) is equal to p+1. It is noted that a smaller or lower value (p+1) of priority indicates a higher priority (level) according to TS23.303, “Proximity-based services (ProSe); Stage 2,” 16.0.0, Jul. 9, 2020, which is hereby incorporated herein by reference in its entirety. The smallest value of priority, i.e., 1, indicates the highest priority, and the largest value of priority, i.e., 8, indicates the lowest priority level.

The priority level of sidelink data may be set by the application layer and is provided to the physical layer.

In Rel-16 NR vehicle-to-everything (V2X) sidelink communications, mode 2 UEs transmit and receive information without network management. UEs allocate resources for themselves from a resource pool for sidelink transmissions. The resource allocation relies on a sensing and reservation process as shown in FIG. 5. FIG. 5 is a diagram 500 showing example timing of sensing and resource selection for Rel-16 NR sidelink transmission, which is usually referred as full sensing. The diagram 500 includes a sensing window 510 during which a UE may monitoring availability of sidelink resources and a resource selection window 520 during which the UE may select an available sidelink resource.

During a sensing procedure, a UE which is to perform sidelink transmission (also referred to as a monitoring UE or sensing UE) detects SCI transmitted in each slot in the sensing window 510 and measures received signal receive power (RSRP) of the resource indicated in the SCI. The monitoring UE may also receive transmissions of data during the sensing window 510 (thus, the monitoring UE is also a receiving UE). For resource reservations for sidelink transmissions of periodic traffic, if a UE occupies a resource on slot m (e.g., a UE k occupies resource on slot m), it will also occupy resource(s) on slot m+q*RRIₖ, where q is an integer, and RRIₖ is a resource reservation interval of UE k. The monitoring UE may detect the SCI of the UE k and the resource occupied by UE k. Detecting the SCI by the monitoring UE may include the steps of receiving and decoding a PSCCH and processing the SCI within the PSCCH, for example.

For aperiodic or dynamic transmissions, a transmitting UE (e.g., the UE k) in sidelink communications may reserve multiple resources and indicate the next resource in its SCI. Therefore, based on the sensing result of the monitoring UE (e.g., based on detection of SCI of UE k), the monitoring UE can determine which resources may be occupied in the future and can avoid selecting those resources for its own sidelink transmission. The monitoring UE may determine whether a resource is occupied based on measured RSRP on the resource during the sensing period (the sensing window 510).

When resource selection is triggered on slot n, based on the sensing result of the monitoring UE in the sensing window 510, i.e., on slots [n−T₀, n−T_{proc,0}], the monitoring UE may select sidelink resources in a resource pool during the resource selection window 520, i.e., on slots [n+T₁, n+T₂]. The variables are defined as follows:
T₀: number of slots with the value determined by resource pool configuration;
T_{proc,0}: time required for a UE to complete the sensing process;
T₁: processing time required for identification of candidate resources and resource selection T₁≤T_{proc,1};
T₂: the last slot of a resource pool for resource selection, which may be left to UE implementation, but in the range of [T₂ₘᵢₙ, PDB], where T₂ₘᵢₙ is the minimum value of T₂, and PDB denotes a packet delay budget, i.e., the remaining time for a UE transmitting a data packet;
T_{proc,1}: maximum time required for a UE to identify candidate resources and select new sidelink resources.

For low power UEs with power savings, they may perform random resource selection during the resource selection window in the same resource pool without performing sensing, as monitoring the SCI increases power consumption. Random resource selection or random selection is a resource selection procedure where a UE randomly selects time and frequency resources for one or more transmission opportunities from candidate resources in a resource selection region/pool. Some UEs performing random resource selection may not have the capability of receiving PSCCH or monitoring PSCCH.

At RANP #86 (RP-193257, Dec. 9-12, 2019, which is hereby incorporated by reference), a Rel-17 work item (WI) on sidelink enhancements was agreed with the following objective:
Specify resource allocation to reduce power consumption of the UEs [RAN1, RAN2]
   Baseline is to introduce the principle of Rel-14 LTE sidelink random resource selection and partial sensing to Rel-16 NR sidelink resource allocation mode 2.
   Note: Taking Rel-14 as the baseline does not preclude introducing a new solution to reduce power consumption for the cases where the baseline cannot work properly.

In Release-17, it is agreed that a resource pool can be shared by UEs with different resource allocation schemes, such as full/partial sensing based resource allocation or random resource selection, i.e., a mixed resource allocation (RA) scenario is supported.

Random resource selection used for sidelink communication may cause problems when different resource allocation schemes operating in a same resource pool are mixed, where power saving UEs (performing random resource selection), e.g., a Rel-17 UE, and UEs (performing full or partial sensing) select resources from the same resource pool for their respective transmissions. One problem that may arise is that a low priority transmission from a power saving UE (performing random resource selection or with re-evaluation or pre-emption disabled) collides with a high priority transmission from a sensing UE. With the mechanisms of re-evaluation and pre-emption, a sensing UE may perform resource reselection to avoid collisions with other UEs including a UE that performs random resource selection or that disables re-evaluation and pre-emption. However, power saving UEs performing random resource selection may not have PSCCH reception/PSCCH monitoring capability to perform re-evaluation and pre-emption, or may disable the function of re-evaluation and pre-emption when operating in a power saving mode. Thus, in this case, they are unable to detect resources that reserved by another UE for data transmission of a higher priority, and consequently they are unable to perform resource reselection if resource collision occurs. As an example, a power saving UE reserves a resource for a sidelink transmission having a first priority level. This resource is also reserved by a UE (sensing UE) who performs re-evaluation and pre-emption for a sidelink transmission having a second priority level greater than the first priority level. The power saving UE, unable to perform re-evaluation and pre-emption, is unaware of the reservation of the resource by the sensing UE. The sensing UE, detecting that the power saving UE reserves the resource and that the power saving UE's sidelink transmission has a lower priority, will not free the resource. The two transmissions will collide at their intended recipients and cause a performance loss.

The priorities (or priority levels) of sidelink traffic herein refers to application priorities at the application layer or packet priorities. An application (packet) priority does not account for implementations at the physical layer. Means for supporting various physical layer priorities and application priorities are described later in the disclosure.

Because a resource pool can also be shared with legacy Rel-16 UEs, the problem also affects Rel-16 sensing UEs and impacts their performance. A Rel-16 sensing UE is able to detect SCI as specified in Rel-16, e.g., the priority field in SCI format 1-A. However, Rel-17 does not specify any new information to be included in SCI, which needs to be considered when designing any solutions to solve the problem described above.

The following provide embodiments for sidelink communication, which may be used as solutions for the above described problem. The embodiments may be applied to scenarios where a resource pool is shared by UEs using different resource allocation schemes, e.g., using a mix of full/partial sensing based resource allocation scheme and random resource selection scheme. The embodiments have advantages of reducing sidelink power consumption, reducing resource collisions and improving sidelink communication performance. The techniques may be applicable for various UEs, e.g., public safety (PS) UEs.

As used herein, a sensing UE refers to a UE that is capable of performing and performs re-evaluation and pre-emption (or resource re-selection) in resource allocation/selection for sidelink communications; and a power saving UE refers to a UE that performs random resource selection, or that is not capable of performing or does not perform re-evaluation and pre-emption in resource allocation/selection for sidelink communications. For example, the power saving UE may not have the capability to perform re-evaluation and pre-emption. A sensing UE and a power saving UE may both select resources from a same resource pool (shared resource pool) for sidelink transmission. The terms “priority” and “priority level” are used interchangeably in the present disclosure. A priority herein refers to a priority of a sidelink transmission or data (e.g., channels/signals), and is referred to as a packet priority or data priority at the application level, unless otherwise provided. In the following description, a number/value p is used to represent a value of a priority. For example, p may be a value in a priority field of SCI in the SCI format 1-A. A smaller value of a priority, i.e., a smaller p, indicates/represents a higher priority level.

Priority Change with New Indicator

In some embodiments, a reservation priority may be configured for a sidelink data (or sidelink transmission/traffic) to be transmitted by a power saving UE. The sidelink data has an associated packet priority. The packet priority of the data is used for processing the data, which is similar to those priorities of data as conventionally used. The reservation priority of the data is specifically defined/configured for resource reservation by the power saving UE to transmit the data on sidelink. The reservation priority of the sidelink data may be higher than the packet priority of the power saving UE (i.e., a value of the reservation priority is smaller than a value of the packet priority). By use of the reservation priority, a sensing UE, who detects a resource reserved/selected by the power saving UE, may be pre-empted from using this resource occupied by the power saving UE and reselect a resource.

In the following description, the packet priority of a data may also be referred to as an original priority of the data, and the reservation priority of the data may also be referred to as an updated priority. The priority value of the reservation priority (i.e., updated priority) of the data may be updated or changed (e.g., increased) based on the priority value of the packet priority (i.e., the original priority) of the data, for sidelink resource reservation.

In some embodiments, the power saving UE may increase its priority based on an original priority of a data to be sent on sidelink, and may be configured with a new indicator indicating its priority change. The original priority of the power saving UE has a value p, and its increased priority (or referred to as an updated priority, or changed priority) has a value represented by p′, which is smaller than p. The priority increase made by the power saving UE may be based on a priority mapping technique, e.g., using a mapping table or a mapping formula/function. By increasing the priority of the power saving UE and indicating of the increased priority, the sensing UE may perform pre-emption and re-select a resource for sidelink transmission if its priority is lower than the updated priority, i.e., if the sensing UE's priority has a value greater than p′. In other words, if the sensing UE selects the same resource for sidelink transmission, based on the updated priority of the power saving UE, the sensing UE may exclude selecting the resource to avoid collision with the power saving UE. As a result, the collision probability between the power saving UE and the sensing UE in the shared resource pool is reduced.

In some embodiments, an indicator may be provided to indicate the change of a priority of sidelink data. As an example, an indicator may indicate an update priority of the sidelink data.

In the following description, the terms “priority p′” and “priority p” are used for ease of description. “priority p′” represents a priority that has a value of p′, and “priority p” represents a priority that has a value of p. Describing that priority p′ is higher than priority p indicates that p′ is smaller than p. This is consistent with the description above, where smaller value of a priority indicates a higher priority level. The term “priority value p” refers to the value p of a priority, and the term “priority value p′” refers to the value p′ of a priority.

Two embodiment approaches are provided below for delivering information of the updated priority. Other approached may also be applicable without departing from the spirit and principle of the present disclosure.

### Embodiment Approach 1: A Power Saving UE Sends an Updated Priority p′ and a New Indicator b

In some embodiments, based on the packet priority p of a sidelink transmission of the power saving UE and a setting of an indicator b, the power saving UE may obtain an updated priority (reservation priority) p′ from a priority mapping. The priority mapping may be implemented using a mapping table or a mapping function/formula, for example. As an example, the mapping table may include a plurality of packet priority values, each of which is mapped to or associated with an indicator b and an updated priority value. The mapping table may be used to derive the updated priority p′ using the packet priority p and the indicator b. To reduce the collision probability, the updated priority may be set, in general, higher than the packet priority, i.e., set to a smaller priority value p′<p. The power saving UE may then transmit the updated priority p′ in the priority field in SCI format 1-A, and may also transmit the new indicator b, which may be carried by a new signal, a new field in the SCI, or using reserved bit(s) in the SCI. As an example, the power saving UE may determine to increase the priority of sidelink data to be transmitted, determine the indicator b to indicate that the priority of sidelink data has changed, and determine the updated priority p′ using the mapping table or the mapping function. The power saving UE then sends the updated priority value and the indicator b on sidelink, in a same message (e.g., a SCI message) or separate messages.

The data priority of a transmitting UE is an important parameter for a receiving (sensing) UE, and it would be desirable to inform the receiving UE of information about a packet priority or a priority in certain range of the transmitting UE. Directly signaling the packet priority level of the transmitting UE in a field of SCI may increase the SCI size by 3 bits, which is a significant amount given the small size of the SCI. It would be beneficial to using fewer bits to achieve this.

When updated priority p′ and the indicator b are sent in a SCI message, a receiving UE receives the SCI and obtains the updated priority value p′ and the indicator b. Knowing the updated priority value p′ and the indicator b, the receiving UE may resolve the packet priority based on a reverse mapping with or without ambiguity. As an example, the receiving UE determines the packet priority of the power saving UE by utilizing a mapping table or a mapping function, and using the received updated priority p′ and the indicator b. The mapping table or mapping function is the same as that used by the power saving UE. The receiving UE determines the packet priority p based on the updated priority p′ and the indicator b utilizing the mapping table or function, which is referred to as a reverse priority mapping or reverse mapping, as it is a reverse process compared with the power saving UE, who determines the updated priority p′ based on the packet priority and the indicator b.

A Rel-17 sensing UE may monitor the SCI transmitted from other UEs. When it detects the SCI and signaling carrying the indicator b from the power saving UE, the sensing UE may obtain the updated priority p′ and the indicator b. The sensing UE may perform pre-emption based on the detected updated priority p′ of the power saving UE, as previously defined in Rel-16, or may perform a new pre-emption behavior based on the value of the indicator b including a virtual priority value “−1” and not performing the pre-emption, which will be described later of the present disclosure. For example, a scale of 0 to 7 can be used to represent the priority with “0” representing the highest priority. A value of “−1” can represent a value higher than “0”.

A Rel-16 sensing UE may monitor the SCI transmitted from other UEs. When the sensing UE detects the SCI from the power saving UE, it will obtain the updated priority p′. The new indicator b is not specified in Rel-16 standard, and the Rel-16 UE cannot detect the new indicator b. The Rel-16 sensing UE may perform pre-emption based on the detected p′ as defined in Rel-16. A Rel-17 sensing UE may monitor a SCI transmitted by a Rel-16 UE. Since a Rel-16 UE does not support the new indicator, there is no updated priority for a Rel-16 UE.

Utilizing the embodiment approach, the collision probability for both the Rel-17 and Rel-16 legacy sensing UEs are reduced.

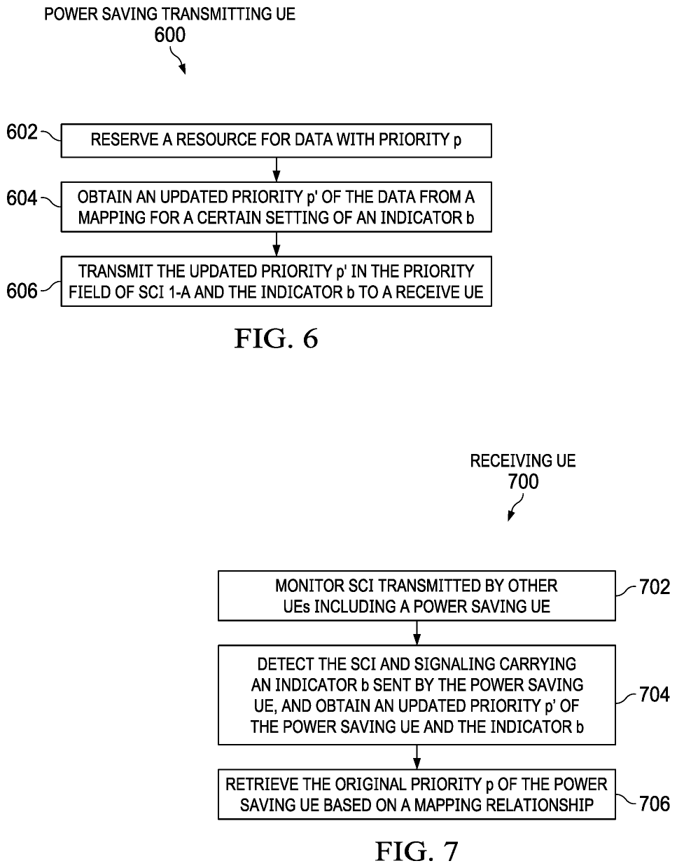

FIG. 6-FIG. 9 in the following provide embodiments where a power saving UE transmits the updated priority and the new indicator b over the air.

FIG. 6 is a flow diagram 600 of an embodiment sidelink communication method, highlighting operations of a power saving transmitting UE. The UE may reserve a resource for transmission of sidelink data having a priority p (block 602). The priority is a packet priority of the sidelink data. For example, the UE may determine a set of resources that are available for sidelink communication from a resource pool, and randomly select the resource from the set of resources. The UE may send a SCI indicating reservation of the resource. The UE may obtain an updated priority p′ of the sidelink data from a mapping for a certain setting of an indicator b (block 604). As an example, the UE may determine the updated priority p′ based on the mapping table or function, as described above. The UE may transmit the updated priority p′ in a priority field of SCI in the SCI format 1-A, and the indicator b as well, to a receive UE (block 606).

FIG. 7 is a flow diagram 700 of an embodiment sidelink communication method, highlighting operations of a receiving UE receiving sidelink transmission from other UEs. The UE may monitor SCI transmitted by other UEs including a power saving UE (block 702). The UE may detect the SCI and signaling carrying an indicator b sent by the power saving UE, and obtain an updated priority p′ of the power saving UE and the indicator b (block 704). The UE may retrieve the original (packet) priority p of the power saving UE based on a mapping relationship (block 706). As an example, the UE may perform a reverse mapping to obtain the original priority p based on a mapping table or function using the indicator b and the updated priority p′ of the power saving UE, as described above.

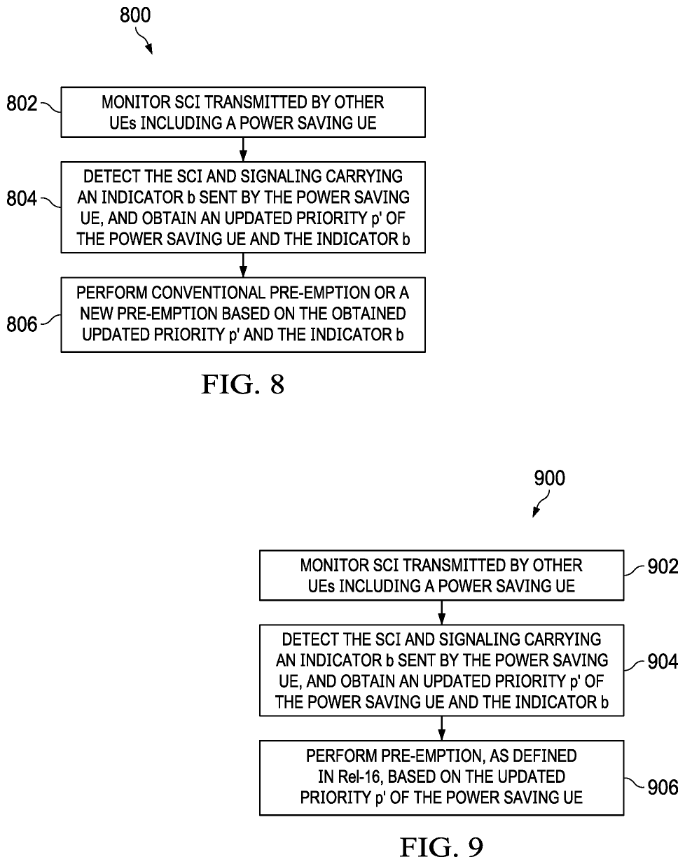

FIG. 8 is a flow diagram 800 of an embodiment sidelink communication method, highlighting operations of a Rel-17 sensing UE. The UE may monitor SCI transmitted by other UEs including a power saving UE (block 802). The UE may detect the SCI and signaling carrying an indicator b sent by the power saving UE, and obtain an updated priority p′ of the power saving UE from the SCI and the indicator b from the signaling (block 804). The UE may perform the conventional pre-emption (as previously described) or a new pre-emption based on the obtained updated priority p′ and the indicator (block 806). For example, the UE may not perform the conventional pre-emption as previously described, but perform the new pre-emption based on the indicator b that has a virtual priority value “−1”.

FIG. 9 is a flow diagram 900 of an embodiment sidelink communication method, highlighting operations of a Rel-16 sensing UE. The UE may monitor SCI transmitted by other UEs including a power saving UE (block 902). The UE may detect the SCI and signaling carrying an indicator b sent by the power saving UE, and obtain an updated priority p′ of the power saving UE from the SCI and the indicator b from the signaling (block 904). The UE may perform the pre-emption, as defined in Rel-16, based on the updated priority p′ of the power saving UE (block 906).

### Embodiment Approach 2: A Power Saving UE Sends the Packet Priority p and the New Indicator b

Based on the packet priority p and a desired priority p′ of sidelink data of the power saving UE, the power saving UE may obtain the setting of the indicator b from priority mapping, e.g., the mapping table or function. The power saving UE may then transmit the packet priority p in the priority field of SCI in SCI format 1-A, and the new indicator b, which may be carried by a new signaling, a new field in the SCI, or using the reserved bit(s) in the SCI.

A sensing UE monitors SCI transmitted from other UEs. When the sensing UE detects the SCI and the indicator b (e.g., carried in a new signaling) from the power saving UE, the sensing UE may obtain the packet priority p and the value of the indicator b. The sensing UE may derive the updated priority p′ of the power saving UE corresponding to the packet priority p and the indicator b based on the priority mapping. The sensing UE may perform pre-emption based on the updated priority p′ as defined in Rel-16, or may have new pre-emption behavior based on the value of the indicator b including a virtual priority −1, without performing the Rel-16 pre-emption, as will be described later.

A Rel-16 sensing UE cannot detect the new indicator b and the packet priority is sent in the SCI of a power saving UE, there is no impact on Rel-16 sensing UEs for performing re-evaluation and pre-emption. As the packet priority is transmitted in the SCI, there is also no change required on sensing UEs either.

In this embodiment approach, the collision probability between the power saving UEs and Rel-17 sensing UEs can be reduced. There is no performance improvement for the Rel-16 legacy sensing UEs. There is no potential priority ambiguity for receiving UEs because the packet priority of the transmitting UE (the power saving UE) is transmitted.

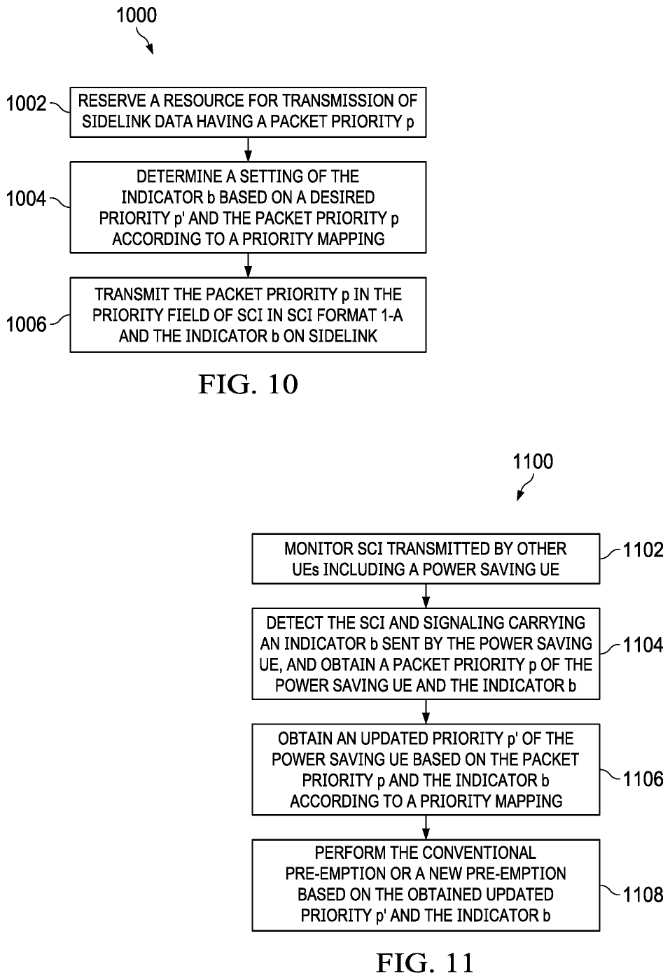

FIG. 10-FIG. 11 in the following provide embodiments where a power saving UE transmits the packet priority and the new indicator b over the air.

FIG. 10 is a flow diagram 1000 of an embodiment sidelink communication method, highlighting operations of a power saving transmitting UE. The UE may reserve a resource for transmission of sidelink data having a packet priority p (block 1002). For example, the UE may determine a set of resources that are available for sidelink communication from a resource pool, and randomly select the resource from the set of resources. The UE may determine a setting of the indicator b based on a desired priority p′ and the packet priority p according to a priority mapping, e.g., a mapping table or function (block 1004). The UE may transmit the packet priority p in the priority field of SCI in SCI format 1-A and the indicator b on sidelink (1006).

FIG. 11 is a flow diagram 1100 of an embodiment sidelink communication method, highlighting operations of a Rel-17 sensing UE. The UE may monitor SCI transmitted by other UEs including a power saving UE (block 1102). The UE may detect the SCI and signaling carrying an indicator b sent by the power saving UE, and obtain a packet priority p of the power saving UE and the indicator b (block 1104). The UE may obtain an updated priority p′ of the power saving UE based on the packet priority p and the indicator b according to a priority mapping (block 1106). The UE may perform the conventional pre-emption (as previously described) or a new pre-emption based on the obtained updated priority p′ and the indicator b (block 1108).

The following provide embodiments for priority mapping and setting of the new indicator b. The priority mapping may be applied to both the two approaches described above, i.e., approaches that send the updated priority or the packet priority in the priority field of SCI 1-A.

In some embodiments, the new indicator b may be a one-bit indicator, and the one-bit indicator may be added to the SCI as a new field or using one of the reserved bits in SCI 1-A. The one-bit indicator indicates whether or not there is a priority difference between the signaled or indicated updated priority level (or value) and the packet priority level (or value). The name of the indicator may be specific for priority update, e.g., the indicator may be called a priority update indicator; or the indicator may be a general indicator of a UE that performs random resource selection, a power saving UE without enabling re-evaluation and pre-emption, a pedestrian UE, or a UE that is concerned with or has lower power consumption, or that is otherwise related to some Rel-17 functionality. When the indicator is a general indicator, other operations than priority mapping may be performed by the UE sending the SCI or the UE receiving the SCI.

In some embodiment, a mapping table may be built, to form a mapping relationship between the packet priority value p (corresponding to the priority level p+1) and the updated priority value p′ (corresponding to the priority level p′+1) for different values of the indicator b. In other words, the mapping table map the packet priority p and the updated priority p′. The mapping may also be referred to as an association. That is, a packet priority value p is associated with an updated priority value p′ for a specific indicator b.

Table 1(a) and Table 1(b) below show an example mapping table. Table 1(a) shows mapping between the packet priority p and the updated priority p′ for different values of the one-bit indicator b, where the mapping is from the packet priority value p to the updated priority p′, e.g., when b=1. Table 1(a) may be used by a UE who sends information about the new indicator b, together with its packet priority p or updated priority p′, according to the embodiment approach 1 described above. Table 1(b) shows mapping between the packet priority p and the updated priority p′ for different values of the one-bit indicator b, where the mapping is from the updated priority p′ to the packet priority value p, e.g., when b=1. Table 1(b) may be used by a UE who receives information of the new indicator b, together with a packet priority p or updated priority p′ of the transmitting UE, according to the embodiment approach 1 described above. Table 1(b) may be used for performing reverse mapping. Table 1(a) and Table 1(b) are the same mapping table showing mapping in opposite directions.

As shown in Error! Reference source not found. (a), when the indicator b=0, there is no change on the priority value, i.e., p′=p. When b=1, the packet priority p=7, 6, 5, 4 is increased to the priority p′=3, 2, 1, 0, respectively. (Please note again that the smaller number p or p′ means a higher priority level). In this example of Table 1, there is no valid entry for the priority p=0, 1, 2, 3 with b=1. This can avoid causing ambiguity when performing reverse mapping from the updated priority p′ to the packet priority p. That is, each value p′ can correspond to at most two entries of p, one for b=0, and the other one for b=1.

The reverse mapping from p′ to p is shown in Table 1(b). When a UE detects the new one-bit indicator b=0, it indicates that there is no change on the priority of a transmitting UE who transmits the indicator b, and the packet priority p equals to the updated priority value p′ detected in the priority field. When b=1, the packet priority value p of the transmitting UE can be retrieved from Table 1(b) based on the detected priority p′. For example, when p′=0, 1, 2, and 3, p=4, 5, 6, and 7, respectively, based on Table 1(b).

TABLE 1(a)

| | Updated | Updated |
|---|---|---|
| | priority value p′ | priority value p′ |
| Packet priority value p | (priority level p′ + 1) | (priority level p′ + 1) |
| (priority level p + 1) | with b = 0 | with b = 1 |
| 0 | 0 | |
| 1 | 1 | |
| 2 | 2 | |
| 3 | 3 | |
| 4 | 4 | 0 |
| 5 | 5 | 1 |
| 6 | 6 | 2 |
| 7 | 7 | 3 |

TABLE 1(b)

| | Packet priority value p | Packet priority value p |
|---|---|---|
| Updated priority value p′ | (priority level p + 1) | (priority level p + 1) |
| (priority level p′ + 1) | when b = 0 | when b = 1 |
| 0 | 0 | 4 |
| 1 | 1 | 5 |
| 2 | 2 | 6 |
| 3 | 3 | 7 |
| 4 | 4 | |
| 5 | 5 | |
| 6 | 6 | |
| 7 | 7 | |

Table 2(a) and Table 2(b) show another example mapping table. Table 2(a) and Table 2(b) are similar to Table 1(a) and Table 1(b). Table 2(a) shows the mapping from the packet priority value p to the updated value p′ with different values of b, and Table 2(b) shows the reverse mapping from the updated priority value p′ to the (recovered) packet priority value p with different values of b. In this example, compared with Tables 1(a) and 1(b), one more priority, i.e., p=3, is increased to a higher priority level, i.e., p′=0; however, the lowest priority p=7 can only be increased to priority p′=4, which is one level lower than the example in Table 1(a).

TABLE 2(a)

| | Updated | Updated |
|---|---|---|
| | priority value p′ | priority value p′ |
| Packet priority value p | (priority level p′ + 1) | (priority level p′ + 1) |
| (priority level p + 1) | with b = 0 | with b = 1 |
| 0 | 0 | |
| 1 | 1 | |
| 2 | 2 | |
| 3 | 3 | 0 |
| 4 | 4 | 1 |
| 5 | 5 | 2 |
| 6 | 6 | 3 |
| 7 | 7 | 4 |

TABLE 2(b)

| | packet priority value p | Packet priority value p |
|---|---|---|
| Updated priority value p′ | (priority level p + 1) | (priority level p + 1) |
| (priority level p′ + 1) | when b = 0 | when b = 1 |
| 0 | 0 | 3 |
| 1 | 1 | 4 |
| 2 | 2 | 5 |
| 3 | 3 | 6 |
| 4 | 4 | 7 |
| 5 | 5 | |
| 6 | 6 | |
| 7 | 7 | |

In some embodiments, multiple packet priorities may be updated to a same priority, e.g., priority value 0. Table 3(a) and 4(a) below show such examples, respectively, where the blank entries in Table 3(a) and 4(a) with b=1 include a value 0. For example, in Table 3(a), all values p=0, 1, 2, 3, 4 map into p′=0, and in Table 4(a), all values p=0, 1, 2, 3 map into p′=0. In this case, as shown Table 3(b) and Table 4(b), there is ambiguity when the embodiment approach 1 is used, because a sensing UE or a receiving UE is unable to determine which packet priority p should be mapped when the updated priority value 0 is received (carried in the priority field of SCI), as each of the packet priority values 0, 1, 2, 3, or 4 in Table 3(a) or 0, 1, 2, or 3 in table 4(a) can be mapped to p′=0. These packet priority values are treated the same in a receiving UE, as they are all mapped to the same p′.

TABLE 3(a)

| | Updated | Updated |
|---|---|---|
| | priority value p′ | priority value p′ |
| Packet priority value p | (priority level p′ + 1) | (priority level p′ + 1) |
| (priority level p + 1) | with b = 0 | with b = 1 |
| 0 | 0 | 0 |
| 1 | 1 | 0 |
| 2 | 2 | 0 |
| 3 | 3 | 0 |
| 4 | 4 | 0 |
| 5 | 5 | 1 |
| 6 | 6 | 2 |
| 7 | 7 | 3 |

TABLE 3(b)

| | Packet priority value p | Packet priority value p |
|---|---|---|
| Updated priority value p′ | (priority level p + 1) | (priority level p + 1) |
| (priority level p′ + 1) | when b = 0 | when b = 1 |
| 0 | 0 | 0, 1, 2, 3, 4 |
| 1 | 1 | 5 |
| 2 | 2 | 6 |
| 3 | 3 | 7 |
| 4 | 4 | |
| 5 | 5 | |
| 6 | 6 | |
| 7 | 7 | |

TABLE 4(a)

| | Updated priority value | Updated priority value |
|---|---|---|
| Packet priority value p | p′ (priority level p′ + | p′ (priority level p′ + |
| (priority level p + 1) | 1) with b = 0 | 1) with b = 1 |
| 0 | 0 | 0 |
| 1 | 1 | 0 |
| 2 | 2 | 0 |
| 3 | 3 | 0 |
| 4 | 4 | 1 |
| 5 | 5 | 2 |
| 6 | 6 | 3 |
| 7 | 7 | 4 |

TABLE 4(b)

| | packet priority value p | Packet priority value p |
|---|---|---|
| Updated priority value p′ | (priority level p + 1) | (priority level p + 1) |
| (priority level p′ + 1) | when b = 0′ | when b = 1 |
| 0 | 0 | 0, 1, 2, 3 |
| 1 | 1 | 4 |
| 2 | 2 | 5 |
| 3 | 3 | 6 |
| 4 | 4 | 7 |
| 5 | 5 | |
| 6 | 6 | |
| 7 | 7 | |

If it is acceptable to have the ambiguity between two consecutive priority levels (e.g., p=0, 1, or p=3, 4), a mapping may be designed as shown in Table 5(a) and Table 5(b). Table 5(a) and Table 5(b) show an example mapping table of priority increase with a one-bit indicator b, and use of this mapping table may cause reverse mapping ambiguity. Table 5(a) maps from the packet priority value p to the increased/updated priority p′ with detected value of b; and Table (b) maps from updated value p′ to packet priority value p with a detected value of b. In Table 5(a) and Table 5(b), two consecutive priorities are mapped to a same updated priority value. For example, as shown in Table 5(a), the packet priority values 0 and 1 (p=0, 1) are both mapped to the updated priority value p′=0, the packet priority values 2 and 3 (p=2, 3) are both mapped to the updated priority value p′=1, the packet priority values 4 and 5 (p=4, 5) are both mapped to the updated priority value p′=2, and so on. In this case, a sensing UE, when receiving information of an updated value p′ (e.g., p′=2) and the indicator b (e.g., b=1), may have ambiguity in determining the packet priority value, which may be p=4 or p=5, as shown in Table 5(b).

TABLE 5(a)

| | Updated priority value | Updated priority value |
|---|---|---|
| Packet priority value p | p′ (priority level p′ + | p′ (priority level p′ + |
| (priority level: p + 1) | 1) with b = 0 | 1) with b = 1 |
| 0 | 0 | 0 |
| 1 | 1 | 0 |
| 2 | 2 | 1 |
| 3 | 3 | 1 |
| 4 | 4 | 2 |
| 5 | 5 | 2 |
| 6 | 6 | 3 |
| 7 | 7 | 3 |

TABLE 5(b)

| | Packet priority value p | Packet priority value p |
|---|---|---|
| Updated priority value p′ | (priority level p + 1) | (priority level p + 1) |
| (priority level p′ + 1) | when b = 0 | when b = 1 |
| 0 | 0 | 0, 1 |
| 1 | 1 | 2, 3 |
| 2 | 2 | 4, 5 |
| 3 | 3 | 6, 7 |
| 4 | 4 | |
| 5 | 5 | |
| 6 | 6 | |
| 7 | 7 | |

The above embodiment mapping table designs may be improved with use of statistical information, and probability information of data priorities of sidelink traffic.

In some embodiments, instead of using a mapping table, a mapping function/formula may be used to derive the packet priority and the updated priority from each other. For example, a mapping function/formula may be p′=max (p−Δp, 0), where Δp is an offset, or referred to as a priority offset. That is, the updated priority value is the packet priority value minus the offset Δp, and has a minimum value 0. As an example, when the offset Δp=3, mapping defined by this mapping function is similar to that shown in Table 3(a). When the above embodiment approach 1 is used, a power saving UE may determine p′ using this mapping function, and signal p′ to other UEs. When the above embodiment approach 2 is used, a sensing UE may use this mapping function to determine p′ of the transmitting UE, and determine whether to perform pre-emption.

The following discuss a virtual priority value “−1” according to some embodiments of the present disclosure.

In some embodiments, a priority mapping may be designed to include a virtual priority value of −1, where a Rel-17 UE will treat its traffic as having a higher priority than a Rel-16 UE traffic having a priority value of 0. Table 6 below shows an example of such a priority mapping. Table 6 shows mapping from the packet priority values p to the increased priority values p′ with one bit indicator b=1. Compared with Tables 1-5 above, Table 6 combines the packet priority values p and the updated priority values p′ when b=0 into one column, as in the case of b=0, p=p′. As shown in Table 6, when b=1, no packet priority value p (from 1 to 7) is mapped to the updated priority p′=0. For p=0 and b=1, a virtual priority value −1 is created (i.e., p′=−1) corresponding to p=0.

Conventionally, when a sensing UE with a data priority p=0 detects a transmitting UE's priority having a value 0 (e.g., p′=0), the sensing UE will not free/release its reserved resource as the two priorities are the same, i.e., both the two UEs have the highest priority. However, in this case, if the sensing UE also detects the new one-bit indicator b=1 from the transmitting UE, the sensing UE knows that the indicator is sent by a power saving UE performing random resource selection, and the sensing UE may free its reserved resource and perform resource reselection. That is to say, in this case, the one-bit indicator b=1 creates an effective higher priority than that of p=0, and this effective higher priority can be represented by a virtual priority value p′=−1. In other words, receipt of p′=0 and b=1 by the sensing UE informs the sensing UE that p′=0 represents a higher priority level than priority value 0. This higher priority level may be represented by value −1, as an example. In some embodiments, a new mapping may be designed and applied in this scenario, as shown in Table 6, where the virtual priority value p′=−1 is created, and is mapped to the packet priority value p=0, where the packet priority value can be reconstructed. In this embodiment design, p′=−1 can only be mapped to p=0 with b=1. If the above described embodiment approach 1 is used, i.e., a power saving UE transmits the updated priority p′ and the indicator b, value 0 is not allowed for the update priority p′ when b=1. The only entry p′=0 with b=1 may be created for case when the embodiment approach 2 is used, i.e., a power saving UE transmits the packet priority p and the indicator b. As an example, if a power saving UE transmits p=3 and b=1, a sensing UE may determine, based on the mapping in Table 6, that p′=0. “0 if sending p” in the second column means that when the power saving UE transmits the packet priority p and the indicator b, the value 0 is used as the mapped updated priority value. The new mapping relationship may be represented as a function p′=max (p−Δp,−1).

TABLE 6

| Packet priority value p | Updated priority value p′ |
|---|---|
| (priority level p + 1) or p′ with | (priority level p′ + 1) with |
| b = 0 | b = 1 |
| 0 | ‘−1’ |
| 1 | |
| 2 | |
| 3 | 0 if sending p |
| 4 | 1 |
| 5 | 2 |
| 6 | 3 |
| 7 | 4 |

In some embodiments, if certain ambiguity is allowed in performing the reverse mapping, as described above, the packet priority values, p=0, 1, 2, 3, may all be mapped to p′=0 with b=1. Detection of p′=0 and b=1 from the SCI may trigger a Rel-17 sensing UE to perform resource reselection and pre-emption even if the sensing UE has a data traffic with the priority 0, which is similar to creating a virtual priority value −1 for the power saving UE who sent p′=0 and b=1. That is, with detection of p′=0 and b=1, the sensing UE may determine that the power saving UE has an updated (reservation) priority value −1, i.e., the power saving UE has a reservation priority higher than a priority having a value 0, and thus determine to perform resource reselection and pre-emption even when the packet priority of the sensing UE has the priority value 0. Table 7 below shows an example mapping that can be used in this scenario. Table 7 shows mapping from the packet priority values p to the increased priority value p′ with b=1, allowing reversing mapping ambiguity. The first column of Table 7 shows the packet priority values p and the updated priority values p′ when b=0. The second column shows the updated priority values p′ when b=1, each is mapped to a packet priority value p. As shown, the packet priority values p=0, 1, 2, 3 are mapped to p′=0 (‘−1’) when b=1, which indicates that their updated priority levels are higher than the priority level having a value 0. The updated priority value p′ when b=1 can represent the value 0 or −1 when transmitted. As an example, p′=0 is transmitted by a power saving UE, and a sensing UE receiving p′=0 and b=1 will interpret that the power saving UE has a priority value −1. In cases where packet priority value p is signaled, one more mapping to 0 is allowed without ambiguity, i.e., for p=3, p′=0, as shown in Error! Reference source not found. “0 (‘−1’) if sending p′/0 if sending p” in the second column indicates that, when the embodiment approach 1 is used and b=1, p′=0 or −1; when the embodiment approach 2 is used and b=1 and p=3, then p′=0 as the mapped updated priority value. When a sensing UE receives p′=0 and b=1, it may not be able to determine which value of p can be mapped based on Table 7. This is (mapping) ambiguity caused by mapping multiple values of p to the same value of p′. Table 7 may be used in scenarios where such ambiguity is allowed or accepted. Note that when putting mapping value 0 (‘−1’) in the table, the value 0 in the same column together with the b setting for the column is used to represent the same meaning, i.e., either priority value a or virtual priority −1. Similar notation can be used in other mapping designs.

TABLE 7

| Packet priority value p | Updated priority value p′ |
|---|---|
| (priority level p + 1) or p′ with | (priority level p′ + 1) with |
| b = 0 | b = 1 |
| 0 | 0 (‘−1’) |
| 1 | 0 (‘−1’) |
| 2 | 0 (‘−1’) |
| 3 | 0 (‘−1’) if sending p′/0 if |
| | sending p |
| 4 | 1 |
| 5 | 2 |
| 6 | 3 |
| 7 | 4 |

In some embodiments, presence of a new field may be used to indicate that there is no priority change. As an example, if the presence of a field (e.g., provided by higher layer signaling (pre-) configuration PC5 RRC) itself indicates that a priority translation is applied, the entry b=0 may not be needed to indicate that there is no change on priority; this, however, may also be used for indicating priority change.

Error! Reference source not found. (a) and Table 8(b) show an embodiment priority mapping between the packet priority p and updated priority p′ with one-bit indicator b. This mapping does not cause any mapping ambiguity. Error! Reference source not found. (a) shows mapping from the packet priority values p to the increased/updated priority values p′ with b=0 and b=1. Error! Reference source not found. (b) shows mapping from the updated values p′ to the packet priority values p with detected value of b. In this example, b=0 is not used to indicate that there is no priority change, instead, it is used, together with b=1, to indicate different priority changes. As shown in Table 8(a), the entries for b=0 show priority value changes/mappings from 0 to 0, from 2 to 1, from 4 to 2 and from 6 to 3; the entries for b=1 show priority value changes/mappings from 1 to 0, from 3 to 1, from 5 to 2 and from 7 to 3. Table 8(b) shows that the same value of p′ is mapped to different values of p when b is different. The case with p′=0 and b=0 may also create a virtual priority value −1. As an example, a sensing UE receiving p′=0 and b=0 from a power saving UE may determine that the power saving UE has a higher priority level even if the sensing UE has a priority value 0, and perform resource reselection. The virtual priority value −1 may be included in Table 8(a) as an alternate embodiment to the value “0”, similar to that described with respect to Table 7. Note that this embodiment mapping may be simply represented by a function p′=(p−b)/2.

TABLE 8(a)

| | Updated priority value | Updated priority value |
|---|---|---|
| Packet priority value p | p′ (priority level p′ + | p′ (priority level p′ + |
| (priority level p + 1) | 1) with b = 0 | 1) with b = 1 |
| 0 | 0 or ‘−1’ | |
| 1 | | 0 |
| 2 | 1 | |
| 3 | | 1 |
| 4 | 2 | |
| 5 | | 2 |
| 6 | 3 | |
| 7 | | 3 |

TABLE 8(b)

| | Packet priority value p | Packet priority value p |
|---|---|---|
| Updated priority value p′ | (priority level p + 1) | (priority level p + 1) |
| (priority level p′ + 1) | when b = 0 | when b = 1 |
| 0 | 0 | 1 |
| 1 | 2 | 3 |
| 2 | 4 | 5 |
| 3 | 6 | 7 |

No Pre-Emption for the Sensing UE when b=1:

In some embodiments, a sensing UE receiving the indicator b=1 may not perform pre-emption. The one-bit indicator b may serve as an indicator indicating random resource selection without need of additional signaling. When the sensing UE detects a lower priority traffic and the indicator b=1, it knows that this is from a UE performing random resource selection. The sensing UE may perform resource reselection to avoid the collision even its own priority is higher than the one it detected. In general, in an embodiment, a Rel-17 sensing UE may not perform pre-emption, but only performs re-evaluation, when it detects the indicator b=1, no matter what the detected priority value is. Note that for mappings without reverse mapping ambiguity, the indicator b=1 serving as indication of random resource selection may only be effective for some packet priority values with mapping as shown in Error! Reference source not found. (a) and Table 1(b), Table 2(a) and Error! Reference source not found. (b), and Table 6. The performance can still be improved, and collision is reduced, as the priority increase correspond to those lower priorities that cause the most performance loss when no enhancement is applied. If allowing ambiguity on the reverse mapping, in some embodiments as described above, the indicator b can serve as a signaling informing Rel-17 sensing UEs to not perform pre-emption and to perform re-evaluation only when collision occurs with power saving UEs of any priority level.

Priority Change with Two-Bit Indication:

With use of the one-bit indicator, some priorities may not be increased to a higher priority level (a lower p′ value), or may not be high enough after the update without reverse mapping ambiguity, which may incur performance loss. In some embodiments, a 2-bit indicator b may be used to improve the performance, e.g., b may have four values, {0,1,2,3}, which may be represented in binary as {‘00’, ‘01’, ‘10’, ‘11’}. The disadvantage is that one more bit is needed in the SCI or one more reserved bit in SCI 1-A is used. But comparing with signaling both the updated priority value p′ and the packet priority value p in SCI, one bit is saved.

A mapping between the packet priority values p and the updated priority values p′ for different settings of the 2-bit b may be formed similarly to the mappings with one-bit b. Because the indicator b can have 4 values in this case, the updated priority value p′ can be mapped to four different packet priority values p including the one with the same value as p′.

Error! Reference source not found. (a) and Error! Reference source not found. (b) below show an example priority mapping using a 2-bit indicator b. In this example, Error! Reference source not found. (a) and Error! Reference source not found. (b) show the mapping from the packet priority values p to the updated priority values p′ with a 2-bit indictor b, and the mapping from the updated priority values p′ to the packet priority values p with detected values of the 2-bit indicator b, respectively. Different settings of a 2-bit indicator b are shown. By use of the mapping, a UE performing random resource selection may signal an updated priority value p′ (e.g., corresponding to a higher priority level) to a receiving UE. The updated priority values p′ may include 0, 1, 2, i.e., the three highest priority levels, in this example. Sensing UEs having a lower priority traffic may reselect a resource with the pre-emption check. For p′=1 and b=1, a virtual priority value −1 may be created, similarly to those described above. The mapping in Error! Reference source not found. (a) and 9(b) may be represented as a mapping function p′=(p−b+1)/3. If a power saving UE sends the packet priority p, there is no impact on the receiving UE.

Note that in Error! Reference source not found. (a), the column for p′ with b=0 is merged with the column for the packet priority values p as they are the same when b=0. Similarly, Error! Reference source not found. (b) does not include a column for mapping p′ to p with b=0, as in this case, p′=p for all the 8 values of p/p′.

TABLE 9(a)

| Packet priority value | Updated priority | Updated priority | Updated priority |
|---|---|---|---|
| p (priority level p + 1) | value p′ (priority level | value p′ (priority level | value p′ (priority level |
| and p′ value with b = 0 | p′ + 1) with b = 1 | p′ + 1) with b = 2 | p′ + 1) with b = 3 |
| 0 | 0 or ‘−1’ | | |
| 1 | | 0 | |
| 2 | | | 0 |
| 3 | 1 | | |
| 4 | | 1 | |
| 5 | | | 1 |
| 6 | 2 | | |
| 7 | | 2 | |

TABLE 9(b)

| | Packet p | Packet p | Packet p |
|---|---|---|---|
| | (priority level | (priority level | (priority level |
| p′ (priority level | p + 1) when | p + 1) when | p + 1) |
| p′ + 1) | b = 1 | b = 2 | when b = 3 |
| 0 | 0 | 1 | 2 |
| 1 | 3 | 4 | 5 |
| 2 | 6 | 7 | |

In some embodiments, if allowing reverse mapping ambiguity, all eight priority levels (p=0˜7) may be mapped to the two highest priority levels, i.e., p′=0, 1 as shown in Error! Reference source not found. (a) and Table 10(b) below. Error! Reference source not found. (a) and Table 10(b) show an example mapping between the packet priority values p and the updated priority values p′ for different values of a two-bit indicator b. This mapping allows reverse mapping ambiguity. Table 10(a) shows mappings from the packet priority values p to the updated priority values p′, with b={0,1,2,3}. Table 10(b) shows mappings from the updated values p′ to the packet priority values p with detected values of b. For p′=0 and b=1, a virtual priority value −1 may be generated as described above. A virtual priority value −1 may also be generated for p′=0 and b=2. For use in cases where packet priority p is sent via SCI 1-A, an additional entry for mapping a packet priority value p to p′=0, instead of mapping to the virtual priority value −1, may be added as shown in the second, third and fourth columns of Table 10(a). As an example, 3 bits in SCI may be used to transmit the indicator b and the reservation priority value p′, with 2 bits used for the indicator, and 1 bit used for p′.

The mapping for the example in Error! Reference source not found. (a) and Table 10(b) can be represented by a function as p′=max ((p−b−1)/3, 0). For the case the packet priority p is sent in SC11-A, an alternative mapping function can be defined as p′=max ((p−b−1)/3, −1).

TABLE 10(a)

| Packet priority value | Updated priority | Updated priority | Updated priority |
|---|---|---|---|
| p (priority level p + 1) | value p′ (priority level | value p′ (priority level | value p′ (priority level |
| and p′ value with b = 0 | p′ + 1) with b = 1 | p′ + 1) with b = 2 | p′ + 1) with b = 3 |
| 0 | 0 (‘−1’) | | |
| 1 | 0 (‘−1’) if sending p′/ | | |
| | 0 if sending p | | |
| 2 | | 0 (‘−1’) | |
| 3 | | 0 (‘−1’) if sending p′/ | |
| | | 0 if sending p | |
| 4 | | | 0 |
| 5 | 1 | | |
| 6 | | 1 | |
| 7 | | | 1 |

TABLE 10(b)

| | Packet p | Packet p | Packet p |
|---|---|---|---|
| | (priority level | (priority level | (priority level |
| p′ (priority level | p + 1) | p + 1) | p + 1) |
| p′ + 1) | when b = 1 | when b = 2 | when b = 3 |
| 0 | 0, 1 | 2, 3 | 4 |
| 1 | 5 | 6 | 7 |

The following provides another embodiment method for updating priority of a sidelink transmission/data. The embodiment may be used to solve the collision problem resulting from low priority transmissions of UEs performing random resource selection in a scenario where mixed RA schemes exist, i.e., power saving UEs (performing random resource selection) and UEs (performing full or partial sensing) select resources from a shared resource pool for their respective transmissions. The embodiment method includes the following:
Introduce an increasing limit (a limitation parameter) ΔPₘₐₓ on the priority change, i.e., a maximum value that a UE can reduce from its packet priority value p. This indicates the highest priority level that the UE can increase to.
Increase the priority value of the UE data within the increasing limit, i.e., p′−p≤ΔPₘₐₓ.
Introduce a new field in SCI or use one or more reserved bit(s) in the SCI to signal a priority difference Δp between the updated priority value p′ and the packet priority value p.

The priority difference may be signaled using the indicator b to a receiving UE. That is, the indicator b may indicate the priority difference Δp. When a power saving UE sends the updated priority value p′ and the priority difference between p and p′ in the SCI (i.e., the indicator b) to the receiving UE, the receiving UE can derive the packet priority of the power saving UE using p=p′+b. When the power saving UE sends the packet priority value p and b, a sensing UE can derive the updated priority by p′=p−b. For 2-bit b, ΔPₘₐₓ may be set to ΔPₘₐₓ=3. In this case, Δp (i.e., b) can take three values: 1, 2, and 3. Mapping tables may be built for this embodiment method as shown in Table 11(a) and Table 11(b). This mapping may be viewed as a special case of priority change with a 2-bit indicator, in view of the increasing limit defined. However, there is no need to specify a mapping table; as an example, the packet priority value can be obtained with the linear equation.

If reverse mapping ambiguity is allowed, the mapping can be represented as:
p′=max (p−b, 0), b=1, 2, 3.

Error! Reference source not found. (a) and Table 11(b) show mapping between the packet priority p and updated priority p′ with a two-bit indicator b indicating a priority difference. Table 11(a) shows mappings from the packet priority values p to the increased priority values p′ with b={0,1,2,3}; Table 11(b) shows mappings from the updated priority values p′ to the packet priority values p with detected b value. When b=0, there is no change on the priority value (i.e., the priority level is not changed). There are multiple packet priority values mapped to the updated priority value 0 in Table 11(a). A receiving UE receives the updated priority value 0 may determine that the transmitting UE's priority is 0 and perform the pre-emption process. In some embodiments, with some settings of the indicator b, the updated priority value 0 can be viewed/understood as priority −1, e.g., transmission of (p′=0, b=1), (p′=0,b=2), or (p′=0,b=3) may be understood as the transmitting UE has priority value −1, which indicates a higher priority level than priority 0. For cases where a power saving UE sends/signals the packet priority p, the mapping may be designed so that for each column of p′, only one mapping from a lower packet priority p to p′=0 is possible, as shown in Error! Reference source not found. (a).

TABLE 11(a)

| Packet priority value | Updated priority | Updated priority | Updated priority |
|---|---|---|---|
| p (priority level p + 1) | value p′ (priority level | value p′ (priority level | value p′ (priority level |
| with b = 0 | p′ + 1) with b = 1 | p′ + 1) with b = 2 | p′ + 1) with b = 3 |
| 0 | 0 (‘−1’) | 0 (‘−1’) | 0 (‘−1’) |
| 1 | 0 (‘−1’) if sending p′/ | 0 (‘−1’) | 0 (‘−1’) |
| | 0 if sending p | | |
| 2 | 1 | 0 (‘−1’) if sending p′/ | 0 (‘−1’) |
| | | 0 if sending p | |
| 3 | 2 | 1 | 0 (‘−1’) if sending p′/ |
| | | | 0 if sending p |
| 4 | 3 | 2 | 1 |
| 5 | 4 | 3 | 2 |
| 6 | 5 | 4 | 3 |
| 7 | 6 | 5 | 4 |

TABLE 11(b)

| | Packet p | Packet p | Packet p |
|---|---|---|---|
| | (priority level | (priority level | (priority level |
| p′ (priority level | p + 1) when | p + 1) when | p + 1) when |
| p′ + 1) | b = 1 | b = 2 | b = 3 |
| 0 | 0, 1 | 0, 1, 2 | 0, 1, 2, 3 |
| 1 | 2 | 3 | 4 |
| 2 | 3 | 4 | 5 |
| 3 | 4 | 5 | 6 |
| 4 | 5 | 6 | 7 |
| 5 | 6 | 7 | |
| 6 | 7 | | |
| 7 | | | |

In some embodiments, a resource pool for sidelink communication may be partitioned into two or more sub-pools or resource zones. The embodiment may be used as a solution to the collision problem occurring in a scenario, where mixed RA schemes exist, i.e., power saving UEs (performing random resource selection) and UEs (performing full or partial sensing) select resources from a shared resource pool for their respective transmissions.

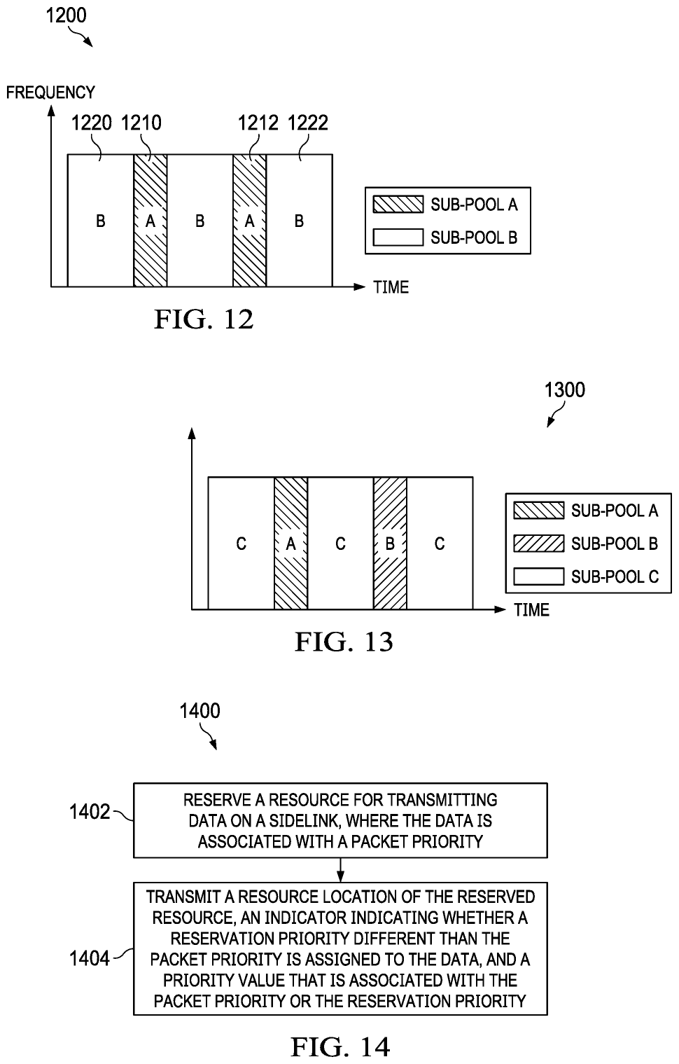

FIG. 12 is a diagram of an embodiment shared resource pool 1200 partitioned into two sub-pools, i.e., sub-pool A and sub-pool B. The partitioning may be in the time and/or frequency domain. A sub-pool may be disjointed or consecutive time slots and/or frequency bandwidth parts. As shown in FIG. 12, sub-pool A includes resource regions 1210 and 1212, and sub-pool B includes resource regions 1220 and 1222. In this example, the resource pool is partitioned in the time domain. In some embodiments, it may be defined that UEs performing random resource selection may select resources for sidelink transmission from one of the sub-pools, e.g., sub-pool A, and sensing UEs (who perform re-evaluation and pre-emption) may select resources for sidelink transmission from the other one of the sub-pools, e.g., sub-pool B. Because a Rel-16 sensing UE with a high priority data does not have the knowledge of the partitioning of the resource pool, its transmissions will still collide with a UE performing random selection. However, because a Rel-16 UE may select a resource from the entire resource pool, the collision probability between the Rel-16 sensing UE with a higher priority and the UE with a lower priority and performing random resource selection when resource partitioning is used is lower than that without resource partitioning.

With use of a resource pool partitioning mechanism, a UE performing random resource selection selects a resource in a smaller sub-pool compared with the entire resource pool, which increases the collision probability among UEs performing random resource selection, particularly when the sub-pool size is small and there are many power saving UEs performing random resource selection. To mitigate this issue, an embodiment method is provided in the following, which supports resource pool partitioning with priority threshold settings. Taking FIG. 12 as an example, the embodiment method includes the following:
Assign a priority threshold Pₜₕ to a sub-pool supporting random resource selection, i.e., the sub-pool (e.g., sub-pool A) used by UEs performing random resource selection. The priority threshold Pₜₕ may be a priority value corresponding to a threshold priority level.

The following may be referred to as resource selection rules:
A UE performing random resource selection:
   selects a resource only in the sub-pool, i.e., sub-pool A, when the data priority of the UE is lower than or equal to the threshold priority level corresponding to the priority threshold Pₜₕ of that sub-pool, i.e., when the data priority value p>=Pₜₕ.
   when the data priority of the UE is higher than the threshold priority level, i.e., when the data priority value p<Pₜₕ, selects a resource from the other sub-pool, i.e., sub-pool B, or select a resource from the entire resource pool.
A sensing UE can either select a resource from sub-pool B or the entire resource pool.
If the resource partitioning is known to the sensing UE, the sensing UE may disable pre-emption in the sub-pool (e.g., sub-pool A) that is configured for low-priority transmissions of UEs performing random selection.

If the shared resource pool is only partitioned into two sub-pools, with one sub-pool configured for power saving UEs (the UEs may generally have a low data priority), then only one priority threshold is needed. The priority threshold may be configured and fixed in the standard or preconfigured for the UEs. The threshold may be made known to both power saving UEs performing random resource selection and sensing UEs performing re-evaluation and pre-emption. Because low priority transmissions from power saving UEs are performed using one sub-pool of the resource pool, and a legacy Rel-16 UE selects a resource from the entire resource pool, the probability of collision between the Rel-16 sensing UE (who may generally have a high priority) and a power saving UE performing random resource selection when the priority threshold is used, is only marginally higher than that when the priority threshold is not used. However, the collision probability among the power saving UEs performing random resource selection can be reduced significantly if Rel-17 sensing UEs and power saving UEs having high priority traffic are not allowed to use the sub-pool.

Partitioning of a resource pool may be configured in a resource pool configuration. The resource pool configuration is preconfigured in a UE, configured by a UE, configured for a UE through radio resource control (RRC) signaling, configured for a UE by another UE, or received by a UE from another UE.

In some embodiments, the mechanism of resource partitioning with priority threshold may be combined with the mechanism of priority increasing, e.g., by applying the resource-pool-partitioning based resource selection rules on sidelink transmissions having the updated priority p′. As an example, a shared resource pool is partitioned into sub-pools A and B as shown in FIG. 12. The above described resource selection rules may be applied by power saving UEs and sensing UEs. A power saving UE increases the packet priority p of a sidelink transmission to p′, and transmits p′ with the indicator b on sidelink. Based on the resource selection rules, the power saving UE may compare p′ with the priority threshold Pₜₕ to determine whether to transmit the sidelink transmission using the sub-pool A or the sub-pool B (or the entire resource pool). A sensing UE receives p′ and the indicator b of the power saving UE, and may reselect a resource from the entire resource pool, or the sub-pool B.

Extensions to Multiple Sub-Pools with Priority Threshold:

In some embodiments, a resource pool may be partitioned into a plurality of sub-pools, and similar resource selection rules may be defined for using these sub-pools. FIG. 13 is a diagram of an embodiment resource pool 1300 partitioned into three sub-pools A, B and C. The following embodiment options for resource selection may be considered.
In some embodiments, for UEs performing random resource selection, a priority range for random resource selection may be assigned to each of some sub-pools, e.g., a priority (level) range 6-8 (i.e., priority values p=5, 6, 7) is assigned to sub-pool A of FIG. 13, and a priority (level) range 3-5 (i.e., priority value p=2, 3, 4) is assigned to sub-pool B of FIG. 13. When a UE performing random resource selection has a data priority falling in a particular priority range, the UE may perform random resource selection only in the sub-pool assigned with this priority range. A UE having a data priority that is not in any of the priority ranges may select a resource in the remaining sub-pool, e.g., sub-pool C.
In some embodiments, a priority threshold Pₜₕ may be assigned for each sub-pool, e.g., P_{th,A}=5 for sub-pool A and P_{th,B}=3 for sub-pool B, and no threshold for sub-pool C (or P_{th,C}=0 implicitly when 0 indicates the highest priority level). The priority threshold Pₜₕ is a priority value in this example.
   In an embodiment, a UE performing random resource selection may select a resource from a sub-pool according to the priority thresholds. As an example, when P_{th,A}>P_{th,B}>P_{th,C}, and the UE may select a resource based on its data priority according to the order of the priority thresholds, e.g., the UE may select a resource in sub-pool A when its data priority value p P_{th,A}, select a resource in sub-pool B when its data priority value p satisfies P_{th,A}>p≥P_{th,B}, and select a resource in sub-pool C when its data priority P_{th,B}>p≥P_{th,C}.
   In an embodiment, a UE performing random resource selection may select a resource in one or more sub-pools when its data priority value p is no higher than the priority threshold(s) of the one or more sub-pools. As an example, when P_{th,A}>P_{th,B}>P_{th,C}, for p≥P_{th,A}, the UE selects a resource in sub-pool A; for P_{th,A}>p≥P_{th,B} the UE selects a resource in sub-pools A and B; for P_{th,B}>p≥P_{th,C}, the UE selects a resource in sub-pools A, B and C, i.e., the entire resource pool.
A sensing UE may be assigned to a sub-pool with the highest priority threshold, e.g., sub-pool C, or no restriction is applied to the sensing UE for resource selection, i.e., the sensing UE uses the entire resource pool.

The above embodiment rules for selecting resources from a shared resource pool partitioned into sub-pools are merely examples provided for illustration purposes. Those of ordinary skill in the art would recognize that various embodiments, alternatives or modification may be applicable without departing from the spirit and principle of the present disclosure.

FIG. 14 is a flow diagram of an embodiment method 1400 for sidelink communication. The method 1400 may be indicative of operations of a power saving UE. The UE may reserve a resource for transmitting data on a sidelink, where the data is associated with a packet priority (block 1402). The resource may be selected randomly by the UE from a resource pool. The UE may transmit a resource location of the reserved resource, an indicator indicating whether a reservation priority different than the packet priority is assigned to the data, and a priority value that is associated with the packet priority or the reservation priority (block 1404).

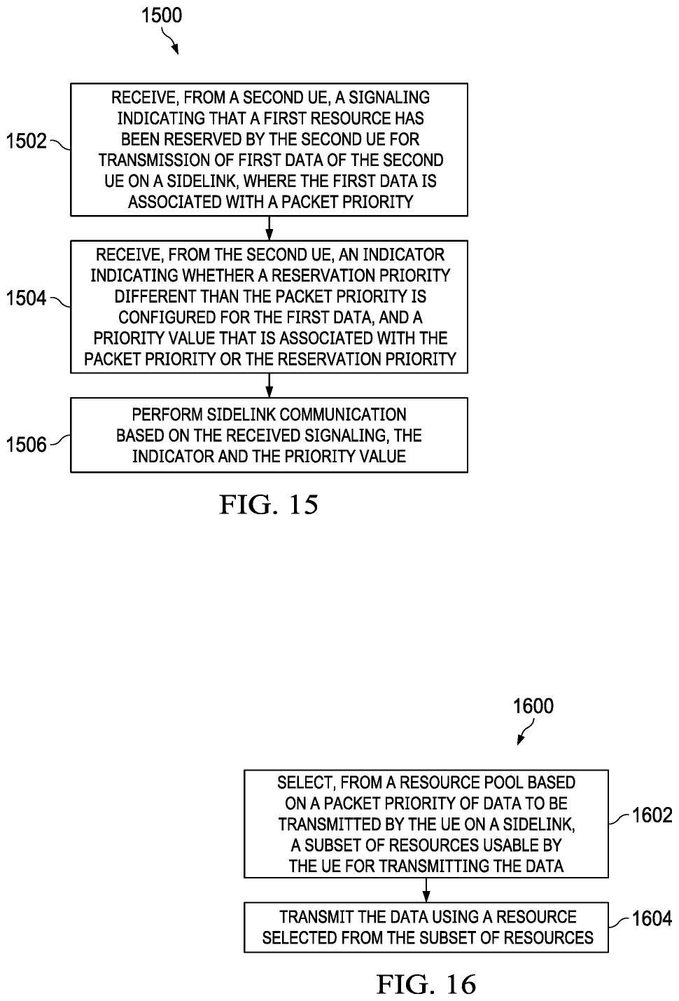

FIG. 15 is a flow diagram of an embodiment method 1500 for sidelink communication. The method 1500 may be indicative of operations of a sensing UE performing re-evaluation and pre-emption for resource selection in sidelink communications. The sensing UE (a first UE) may receive, from a second UE, a signaling indicating that a first resource has been reserved by the second UE for transmission of first data of the second UE on a sidelink, where the first data is associated with a packet priority (block 1502). The first resource belongs to a resource pool configured for sidelink communication. The first UE receives, from the second UE, an indicator indicating whether a reservation priority different than the packet priority is configured for the first data, and a priority value that is associated with the packet priority or the reservation priority (block 1504). The first UE performs sidelink communication based on the received signaling, the indicator and the priority value (block 1506).

FIG. 16 is a flow diagram of an embodiment method 1600 for sidelink communication. The method 1600 may be indicative of operations of a power saving UE. The UE may select, from a resource pool based on a packet priority of data to be transmitted by the UE on a sidelink, a subset of resources usable by the UE for transmitting the data (block 1602). The resource pool includes one or more subsets of resources according to a resource pool configuration, and each subset of the one or more subsets is associated with a set of priority values. The UE may transmit the data using a resource selected from the subset of resources (block 1604).

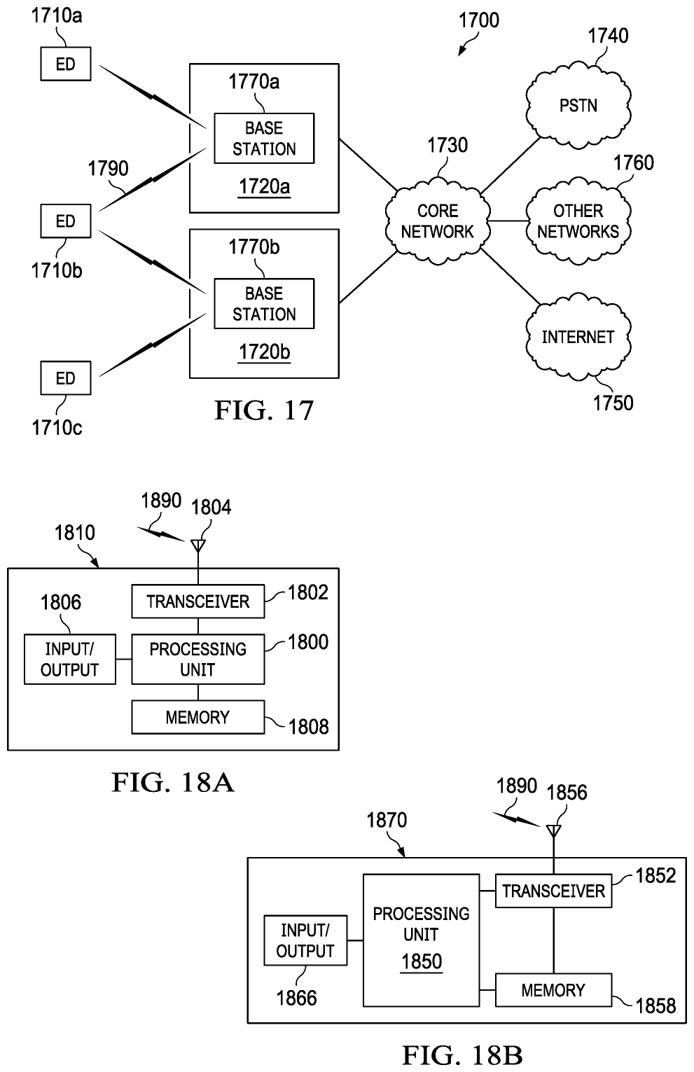

FIG. 17 is a diagram of an example communication system 1700. In general, the system 1700 enables multiple wireless or wired users to transmit and receive data and other content. The system 1700 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1700 includes electronic devices (ED) 1710a-1710c, radio access networks (RANs) 1720a-1720b, a core network 1730, a public switched telephone network (PSTN) 1740, the Internet 1750, and other networks 1760. While certain numbers of these components or elements are shown in FIG. 17, any number of these components or elements may be included in the system 1700.

The EDs 1710a-1710c are configured to operate or communicate in the system 1700. For example, the EDs 1710a-1710c are configured to transmit or receive via wireless or wired communication channels. Each ED 1710a-1710c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1720a-1720b here include base stations 1770a-1770b, respectively. Each base station 1770a-1770b is configured to wirelessly interface with one or more of the EDs 1710a-1710c to enable access to the core network 1730, the PSTN 1740, the Internet 1750, or the other networks 1760. For example, the base stations 1770a-1770b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (ΔP), or a wireless router. The EDs 1710a-1710c are configured to interface and communicate with the Internet 1750 and may access the core network 1730, the PSTN 1740, or the other networks 1760.

In the embodiment shown in FIG. 17, the base station 1770a forms part of the RAN 1720a, which may include other base stations, elements, or devices. Also, the base station 1770b forms part of the RAN 1720b, which may include other base stations, elements, or devices. Each base station 1770a-1770b operates to transmit or receive wireless signals within a particular geographic region or area, sometimes referred to as a “cell.” In some embodiments, multiple-input multiple-output (MIMO) technology may be employed having multiple transceivers for each cell.

The base stations 1770a-1770b communicate with one or more of the EDs 1710a-1710c over one or more air interfaces 1790 using wireless communication links. The air interfaces 1790 may utilize any suitable radio access technology.

It is contemplated that the system 1700 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1720a-1720b are in communication with the core network 1730 to provide the EDs 1710a-1710c with voice, data, application, Voice over Internet Protocol (VoIP), or other services. Understandably, the RANs 1720a-1720b or the core network 1730 may be in direct or indirect communication with one or more other RANs (not shown). The core network 1730 may also serve as a gateway access for other networks (such as the PSTN 1740, the Internet 1750, and the other networks 1760). In addition, some or all of the EDs 1710a-1710c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1750.

Although FIG. 17 illustrates one example of a communication system, various changes may be made to FIG. 17. For example, the communication system 1700 could include any number of EDs, base stations, networks, or other components in any suitable configuration.

FIGS. 18A and 18B illustrate example devices that may implement the methods and teachings according to this disclosure. In particular, FIG. 18A illustrates an example end device (ED) or a terminal device 1810, and FIG. 18B illustrates an example base station 1870. These components could be used in the system 1700 or in any other suitable system.

As shown in FIG. 18A, the ED 1810 includes at least one processing unit 1800. The processing unit 1800 implements various processing operations of the ED 1810. For example, the processing unit 1800 could perform signal coding, data processing, power control, input/output processing, or any other functionality enabling the ED 1810 to operate in the system 1700. The processing unit 1800 also supports the methods and teachings described in more detail above. Each processing unit 1800 includes any suitable processing or computing device configured to perform one or more operations. Each processing unit 1800 could, for example, include a microprocessor, microcontroller, digital signal processor, field programmable gate array, or application specific integrated circuit.

The ED 1810 also includes at least one transceiver 1802. The transceiver 1802 is configured to modulate data or other content for transmission by at least one antenna or NIC (Network Interface Controller) 1804. The transceiver 1802 is also configured to demodulate data or other content received by the at least one antenna 1804. Each transceiver 1802 includes any suitable structure for generating signals for wireless or wired transmission or processing signals received wirelessly or by wire. Each antenna 1804 includes any suitable structure for transmitting or receiving wireless or wired signals 1890. One or multiple transceivers 1802 could be used in the ED 1810, and one or multiple antennas 1804 could be used in the ED 1810. Although shown as a single functional unit, a transceiver 1802 could also be implemented using at least one transmitter and at least one separate receiver.

The ED 1810 further includes one or more input/output devices 1806 or interfaces (such as a wired interface to the Internet 1750). The input/output devices 1806 facilitate interaction with a user or other devices (network communications) in the network. Each input/output device 1806 includes any suitable structure for providing information to or receiving information from a user, such as a speaker, microphone, keypad, keyboard, display, or touch screen, including network interface communications.

In addition, the ED 1810 includes at least one memory 1808. The memory 1808 stores instructions and data used, generated, or collected by the ED 1810. For example, the memory 1808 could store software or firmware instructions executed by the processing unit(s) 1800 and data used to implement the embodiment methods. Each memory 1808 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 18B, the base station 1870 includes at least one processing unit 1850, at least one transceiver 1852, which includes functionality for a transmitter and a receiver, one or more antennas 1856, at least one memory 1858, and one or more input/output devices or interfaces 1866. A scheduler, which would be understood by one skilled in the art, is coupled to the processing unit 1850. The scheduler could be included within or operated separately from the base station 1870. The processing unit 1850 implements various processing operations of the base station 1870, such as signal coding, data processing, power control, input/output processing, or any other functionality. The processing unit 1850 can also support the methods and teachings described in more detail above. Each processing unit 1850 includes any suitable processing or computing device configured to perform one or more operations. Each processing unit 1850 could, for example, include a microprocessor, microcontroller, digital signal processor, field programmable gate array, or application specific integrated circuit.

Each transceiver 1852 includes any suitable structure for generating signals for wireless or wired transmission to one or more EDs or other devices. Each transceiver 1852 further includes any suitable structure for processing signals received wirelessly or by wire from one or more EDs or other devices. Although shown combined as a transceiver 1852, a transmitter and a receiver could be separate components. Each antenna 1856 includes any suitable structure for transmitting or receiving wireless or wired signals 1890. While a common antenna 1856 is shown here as being coupled to the transceiver 1852, one or more antennas 1856 could be coupled to the transceiver(s) 1852, allowing separate antennas 1856 to be coupled to the transmitter and the receiver if equipped as separate components. Each memory 1858 includes any suitable volatile or non-volatile storage and retrieval device(s). Each input/output device 1866 facilitates interaction with a user or other devices (network communications) in the network. Each input/output device 1866 includes any suitable structure for providing information to or receiving/providing information from a user, including network interface communications.

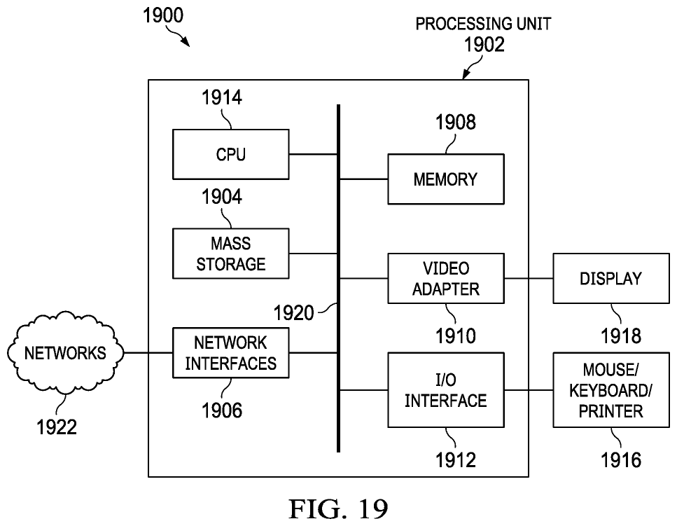

FIG. 19 is a block diagram of a computing system 1900 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1900 includes a processing unit 1902. The processing unit includes a central processing unit (CPU) 1914, memory 1908, and may further include a mass storage device 1904, a video adapter 1910, and an I/O interface 1912 connected to a bus 1920.

The bus 1920 may be one or more of any type of several bus architectures including a memory bus or memory controller, a peripheral bus, or a video bus. The CPU 1914 may comprise any type of electronic data processor. The memory 1908 may comprise any type of non-transitory system memory such as static random access memory (SRAM), dynamic random access memory (DRAM), synchronous DRAM (SDRAM), read-only memory (ROM), or a combination thereof. In an embodiment, the memory 1908 may include ROM for use at boot-up, and DRAM for program and data storage for use while executing programs. The memory 1908 may include instructions executable by the processing unit 1902.

The mass storage 1904 may comprise any type of non-transitory storage device configured to store data, programs, and other information and to make the data, programs, and other information accessible via the bus 1920. The mass storage 1904 may comprise, for example, one or more of a solid state drive, hard disk drive, a magnetic disk drive, or an optical disk drive.

The video adapter 1910 and the I/O interface 1912 provide interfaces to couple external input and output devices to the processing unit 1902. As illustrated, examples of input and output devices include a display 1918 coupled to the video adapter 1910 and a mouse, keyboard, or printer 1916 coupled to the I/O interface 1912. Other devices may be coupled to the processing unit 1902, and additional or fewer interface cards may be utilized. For example, a serial interface such as Universal Serial Bus (USB) (not shown) may be used to provide an interface for an external device.

The processing unit 1902 also includes one or more network interfaces 1906, which may comprise wired links, such as an Ethernet cable, or wireless links to access nodes or different networks. The network interfaces 1906 allow the processing unit 1902 to communicate with remote units via the networks. For example, the network interfaces 1906 may provide wireless communication via one or more transmitters/transmit antennas and one or more receivers/receive antennas. In an embodiment, the processing unit 1902 is coupled to a local-area network 1922 or a wide-area network for data processing and communications with remote devices, such as other processing units, the Internet, or remote storage facilities.

In some embodiments, the computing system 1900 may comprise an apparatus configured to implement the embodiments of the present disclosure. The processing units 1902 may execute the instructions stored in the memory 1908 to cause the apparatus to perform the embodiment methods of the present disclosure.

All or some of the foregoing embodiments may be implemented by software, hardware, firmware, or any combination thereof. When software is used for implementation, the embodiments may be implemented completely or partially in a form of a computer program product. The computer program product includes one or more computer instructions. When the computer program instruction is loaded and executed on a computer, all or some of the procedures or functions are generated according to the embodiments of the present disclosure. The computer may be a general-purpose computer, a special-purpose computer, a computer network, or another programmable apparatus. The computer instruction may be stored in a computer-readable storage medium or may be transmitted from a computer-readable storage medium to another computer-readable storage medium. For example, the computer instruction may be transmitted from a website, computer, server, or data center to another website, computer, server, or data center in a wired (for example, a coaxial cable, an optical fiber, or a digital subscriber line) or wireless (for example, infrared, microwave, or the like) manner. The computer-readable non-transitory media includes all types of computer readable media, including magnetic storage media, optical storage media, flash media or solid state storage media.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a determining unit/module, an obtaining unit/module, an priority updating unit/module, an indicating unit/module, a resource selecting unit/module, a resource pool partitioning unit/module, a re-evaluating unit/module, a pre-emption unit/module, a resource reserving unit/module, and/or a priority mapping unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method comprising:
selecting, by a user equipment (UE) from a resource pool based on a packet priority of data to be transmitted by the UE on a sidelink, a first subset of resources usable by the UE for transmitting the data, the resource pool comprising one or more subsets of resources according to a resource pool configuration, and each subset of the one or more subsets being associated with a set of priority values; and
transmitting, by the UE on the sidelink, the data using a resource selected from the first subset of resources.

2. The method of claim 1, wherein the first subset of resources is selected when the packet priority of the data satisfies a condition associated with the set of priority values of the first subset of resources.

3. The method of claim 1, wherein selecting the first subset of resources comprise:
comparing, by the UE, a priority value of the packet priority of the data with the set of priority values.

4. The method of claim 1, wherein the set of priority values comprises a priority threshold or a range of priorities.

5. The method of claim 4, wherein selecting the first subset of resources comprise:
determining, by the UE, whether a priority value of the packet priority is in the range of priorities of the first subset of resources.

6. The method of claim 1, wherein the resource pool configuration is preconfigured.

7. The method of claim 1, wherein the resource pool configuration is preconfigured by the network.

8. The method of claim 1, wherein the resource pool configuration is received by the UE through radio resource control (RRC) signaling.

9. The method of claim 1, wherein the resource pool configuration is received by the UE from another UE.

10. An apparatus comprising:
a non-transitory memory storage comprising instructions; and
one or more processors in communication with the memory storage, wherein the instruction, when executed by the one or more processors, cause the apparatus to perform:
selecting from a resource pool based on a packet priority of data to be transmitted by the apparatus on a sidelink, a first subset of resources usable by the apparatus for transmitting the data, the resource pool comprising one or more subsets of resources according to a resource pool configuration, and each subset of the one or more subsets being associated with a set of priority values; and
transmitting, on the sidelink, the data using a resource selected from the first subset of resources.

11. The apparatus of claim 10, wherein the first subset of resources is selected when the packet priority of the data satisfies a condition associated with the set of priority values of the first subset of resources.

12. The apparatus of claim 10, wherein selecting the first subset of resources comprise:
comparing, by the apparatus, a priority value of the packet priority of the data with the set of priority values.

13. The apparatus of claim 10, wherein the set of priority values comprises a priority threshold or a range of priorities.

14. The apparatus of claim 13, wherein selecting the first subset of resources comprise:
determining, by the apparatus, whether a priority value of the packet priority is in the range of priorities of the first subset of resources.

15. The apparatus of claim 10, wherein the resource pool configuration is preconfigured.

16. The apparatus of claim 10, wherein the resource pool configuration is preconfigured by the network.

17. The apparatus of claim 10, wherein the resource pool configuration is received by the apparatus through radio resource control (RRC) signaling.

18. The apparatus of claim 10, wherein the apparatus comprises a user equipment (UE) and wherein the resource pool configuration is received by the UE from another UE.

19. A system comprising:
a first user equipment (UE); and
a second UE in communication with the first UE; and
wherein the first UE is configured to: reserve a resource for transmitting data on a sidelink, the data associated with a packet priority; and transmit, on the sidelink, a resource location of the reserved resource, an indicator indicating whether a reservation priority different than the packet priority is assigned to the data, and a priority value that is associated with the packet priority or the reservation priority; and
wherein the second UE is configured to: receive the resource location of the reserved resource, the indicator and the priority value; and perform sidelink communication based on the resource location of the reserved resource, the indicator and the priority value.

20. The system of claim 19, wherein a first subset of resources is selected when the packet priority of the data satisfies a condition associated with the set of priority values of the first subset of resources.
